(19) United States
(12) Patent Application Publication
(10) Pub. No.: US 2017/0169508 A1
(43) Pub. Date: Jun. 15, 2017

(54) ENABLING PEER-TO-PEER LOAN TRANSACTION

(71) Applicant: Facebook, Inc., Menlo Park, CA (US)

(72) Inventors: Shuo Song, Palo Alto, CA (US); Jennifer JenJen Tung, Austin, TX (US); Stephen Moore Davis, San Francisco, CA (US); Pratap Prabhu, Fremont, CA (US); Akshay Mittal, Mountain View, CA (US); Yichen Jia, Sunnyvale, CA (US); Alvin Portillo, Menlo Park, CA (US); Shen Wang, Mountain View, CA (US); Phannipha Arunyaangkul, Seattle, WA (US); Kevin Patrick Hurley, Menlo Park, CA (US); Xunjie Yu, Santa Clara, CA (US)

(21) Appl. No.: 14/965,784

(22) Filed: Dec. 10, 2015

(51) Int. Cl. G06Q 40/02; G06Q 20/10; G06Q 50/00; G06Q 20/22

(52) U.S. Cl. CPC G06Q 40/025; G06Q 20/223; G06Q 20/102; G06Q 50/01

(57) ABSTRACT

The present disclosure relates to systems, methods, and devices for enabling peer-to-peer loan transactions. In particular, the message system allows users of a social networking system to initiate peer-to-peer loan transactions. For example, one or more implementations involve recommending potential lenders likely to loan money to a user requesting a peer-to-peer loan transaction. One or more embodiments of the message system provide a loan request message to a potential lender. Additionally, one or more embodiments receive an acceptance of the requested loan transaction and initiate the loan transaction by transferring a loan amount from a payment credential of the potential lender to the user.

### BACKGROUND

1. Technical Field

One or more embodiments described herein relate generally to systems and methods for enabling peer-to-peer loan transactions. More specifically, one or more embodiments relate to systems and methods of enabling electronic peer-to-peer loan transactions between users of a social networking system.

2. Background and Relevant Art

As the use and prevalence of computing devices has grown, the frequency and availability of electronic payment transactions has also increased. Specifically, many software applications allow users to engage in peer-to-peer electronic payment transactions with other users. Electronic payment transactions allow users to transfer money to other users (e.g., peer-to-peer payment transactions) without requiring either of the users to visit a physical banking location or to exchange physical currencies or equivalents.

For example, some conventional electronic payment systems allow a user to transfer money to another user by way of a mobile device running a mobile software application. Users can input payment credentials into the mobile application, allowing the conventional electronic payment systems to verify payment information and perform requested payment transfers. Such conventional electronic payment systems, however, are limited in the types of available payment transactions and ways in which the users can engage with each other.

Due to the ease of electronic payments, electronic payments systems are often used to solicit money or loans. For example, some conventional electronic payment systems allow users to establish crowdfunding payment transactions in which many users combine to provide funds for a single purpose. Specifically, crowdfunding can include electronic payment transactions by a plurality of different users for a single user or entity. While crowdfunding provides users with a way to obtain funds from a plurality of different individual users, crowdfunding is typically a way for users to use the funds as a gift or in exchange for a product. Additionally, conventional payment systems that implement crowdfunding payment transactions are often required to conform to certain guidelines that can be burdensome to the payment systems.

Additionally, many conventional loan entities provide loans to individuals for a variety of purposes. Some conventional loan entities, however, limit the availability or terms of individual loans based on credit histories. Thus, some individuals may be barred from obtaining individual loans due to poor or non-existent credit history. Other conventional loan entities provide loans to individuals with poor/non-existent credit history or to users who need access to funds quickly, but at very high interest rates or with other unfavorable terms. Individuals who take out such loans often end up repaying many more times the amount of the initial loan.

To overcome such a problem, some conventional electronic payment systems provide users with a way to receive loans funded by other individual users by way of a third-party lender. In particular, some conventional electronic payment systems allow one or more individual users to send money to a third-party lender that then establishes a loan for a single individual user or entity. Allowing users to lend money to a third-party lender can allow users to obtain loans that the users might not otherwise be able to obtain, but also introduces complexity and limitations that might limit the availability of such services to certain geographic locations or financial institutions. Additionally, such conventional systems can also be limited in how quickly a user is able to obtain a loan funded by other users.

Accordingly, there are a number of disadvantages with conventional electronic payment systems and methods.

### SUMMARY

One or more embodiments described herein provide benefits and/or solve one or more of the foregoing or other problems in the art with systems and methods to enable electronic peer-to-peer loan transactions. In particular, one or more embodiments allow users of a social networking system to engage in peer-to-peer loan transactions. For example, the systems and methods allow a user to request to initiate a peer-to-peer loan transaction with one or more co-users of a social networking system and establish loan terms for the loan transaction. One or more embodiments provide loan request messages to potential lenders of the social networking system. The systems and methods also initiate the loan transaction with a potential lender that has accepted the loan transaction by transferring a loan amount from a payment credential of the lender to a payment credential of the user. Thus, the systems and methods allow users to enter into individual loan transactions directly with one or more potential lenders of the social networking system.

Additionally, the systems and methods recommend one or more potential lenders to the user. Specifically, the one or more embodiments identify one or more potential lenders from a plurality of co-users of the social networking system based on information maintained by the social networking system. For example, one or more embodiments identify one or more co-users likely to loan money to the user. By recommending potential lenders based on information maintained by the social networking system, the systems and methods improve the likelihood that the user will be able to initiate a loan transaction with one of the co-users of the social networking system.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. In the following drawings, bracketed text and blocks with dashed borders (e.g., large dashes, small dashes, dot-dash, dots) are used herein to illustrate optional features or operations that add additional features to embodiments of the disclosure. Such notation, however, should not be taken to mean that these are the only options or optional operations, and/or that blocks with solid borders are not optional in certain embodiments of the disclosure. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates a schematic diagram of an example system that facilitates the sending of messages and payments in accordance with one or more embodiments;

FIG. 2 illustrates a detailed schematic diagram of the system of FIG. 1 in accordance with one or more embodiments;

FIGS. 3A-3C illustrate a sequence-flow diagram illustrating interactions as part of a loan process between a borrower and a lender in accordance with one or more embodiments;

FIGS. 4A-4G illustrate user interfaces for requesting a loan transaction as described in reference to FIGS. 3A-3C in accordance with one or more embodiments;

FIGS. 5A-5F illustrate user interfaces for initiating a loan transaction as described in reference to FIGS. 3A-3C in accordance with one or more embodiments;

FIG. 6 illustrates a flow chart of a series of acts in a method of enabling peer-to-peer loan transactions in accordance with one or more embodiments;

FIG. 7 illustrates a block diagram of an example computing device in accordance with one or more embodiments;

FIG. 8 illustrates an example network environment of a social-networking system in accordance with one or more embodiments; and

FIG. 9 illustrates an example social graph for a social-networking system in accordance with one or more embodiments.

### DETAILED DESCRIPTION

Embodiments of the present disclosure provide a peer-to-peer loan system that provides users with the ability to engage in peer-to-peer loan transactions. In particular, one or more embodiments provide a peer-to-peer loan system that integrates an electronic payment system and an electronic messaging system. The peer-to-peer loan system allows one or more users to initiate peer-to-peer loan transactions as well as send and receive messages associated with the loan transactions. For example, the peer-to-peer loan system allows a user of a social networking system to send a request to initiate a peer-to-peer loan transaction to one or more co-users of the social networking system via a messaging interface. Additionally, the peer-to-peer loan system allows a co-user to accept a loan transaction with the user via the messaging interface.

By allowing users to initiate peer-to-peer loan transactions with co-users, the peer-to-peer loan system provides greater access to funds that some users might not otherwise be able to obtain. Specifically, the peer-to-peer loan system can allow users to enter into individual loans directly with one or more co-users of a social networking system without having to engage with a third party, such as a broker or financial institution. By providing access to peer-to-peer loans, the peer-to-peer loan system can allow even users with no or poor credit history to obtain loans by engaging with other co-users of the social networking system.

As mentioned, the peer-to-peer loan system integrates an electronic payment system with an electronic messaging system to allow users to send and receive messages associated with loan transactions. For example, the peer-to-peer loan system allows users to request to initiate a loan transaction with one or more co-users of the social networking system by sending a loan request message that appears in a messaging thread or a messaging feed associated with the co-users. Additionally, the co-users can reply to the loan request message within the same messaging thread or messaging feed. By allowing the user and co-users to communicate in the loan request message messaging thread/feed, the user and the co-users can discuss and or customize one or more loan transactions and associated terms.

Based on the loan terms, the peer-to-peer loan system can also facilitate repayment of the loan amount by the user after initiating the loan transaction by transferring funds from a payment credential of the co-user to a payment credential of the user. Specifically, the peer-to-peer loan system can set up a repayment plan based on the loan terms of a loan transaction between the user and a co-user. The peer-to-peer loan system can thereafter transfer funds from the payment credential of the user to the payment credential of the co-user in one or more repayment transactions in accordance with the established loan terms.

In one or more embodiments, the peer-to-peer loan system provides recommendations of potential lenders to a user requesting to initiate a peer-to-peer loan. In particular, the peer-to-peer loan system identifies one or more co-users likely to loan money to the user based on information maintained by the social networking system. For example, the social networking system can maintain loan and payment transaction information and/or other possible cues that indicate a potential lender. Thus, the peer-to-peer loan system can provide the user with candidates that are most likely to result in a successfully funded peer-to-peer loan while also reducing the probability of users spamming co-users with requests that are not likely to be relevant.

According to one or more embodiments, the peer-to-peer loan system can also allow a user to enter into separate loan transactions with a plurality of co-users to fund a loan amount. Specifically, a user can provide a loan message to a plurality of potential lenders, each of which can enter into a loan transaction with the user for a portion of the loan amount. Allowing a user to enter into a plurality of loan transactions with individual co-users in multiple partial amounts can increase the probability of the user finding co-users who are willing to lend to the user to fund the full loan amount.

One or more embodiments of the peer-to-peer loan system also allow users of the social networking system to vouch for loan transaction requests by other users. For example, the peer-to-peer loan system can provide an option for co-users to comment on the veracity of a loan transaction by a user. Additionally, the peer-to-peer loan system can provide a formal method of vouching for or guaranteeing a loan transaction. To illustrate, if a co-user guarantees a loan transaction, the vouching co-user can repay at least a partial amount of the loan transaction to a lender if the borrowing user defaults on the loan transaction. Thus, the peer-to-peer loan system can provide potential lenders with greater security when engaging in peer-to-peer loan transactions with other users of the social networking system.

As used herein, the terms “peer-to-peer loan transaction” and “loan transaction” refer to a payment transaction between two individual users. For example, a peer-to-peer loan transaction involves an individual lender user loaning funds to an individual borrower user with the intent for the borrower user to repay the lender user. Specifically, a peer-to-peer loan transaction can involve transferring funds from a payment credential (e.g., a debit card account) of a lender user to a payment credential of a borrower user. Additionally, a peer-to-peer loan transaction can include loan terms that establish a repayment schedule for transferring funds from the borrower to the lender.

As used herein, the term “potential lender” refers to an individual user likely to loan money to another user. In particular, a potential lender can include a co-user of a social networking system who meets certain criteria established by the social networking system. Additionally, the social networking system can identify potential lenders using information maintained by the social networking system, including previous payment transactions, loan transactions, relationships of the co-users to a user requesting a peer-to-peer loan transaction, etc.

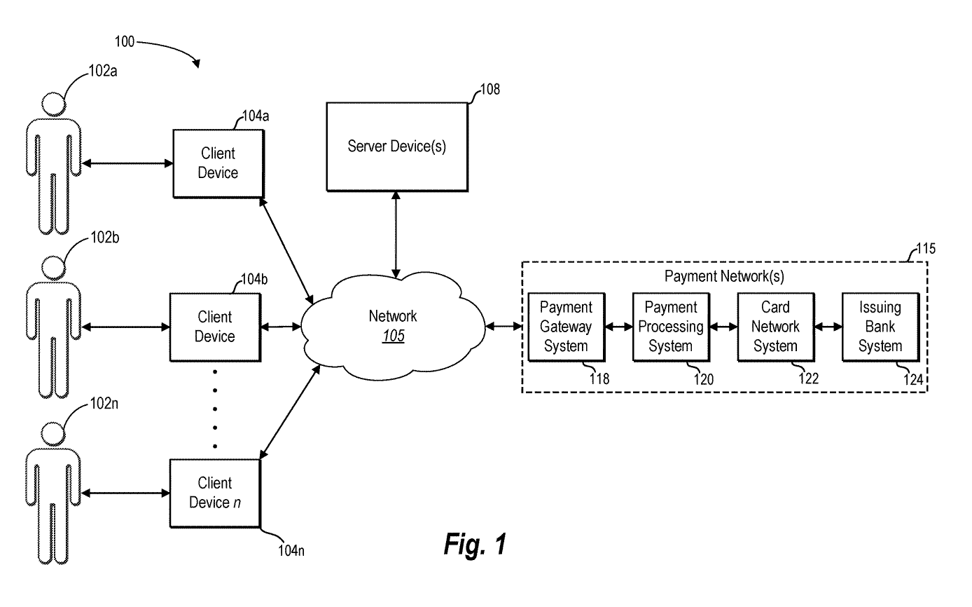

FIG. 1 is a schematic diagram illustrating a peer-to-peer loan system 100 in accordance with one or more embodiments. An overview of the peer-to-peer loan system 100 is described in relation to FIG. 1. Thereafter, a more detailed description of the components and processes of the peer-to-peer loan system 100 are provided in relation to the remaining figures.

As illustrated by FIG. 1, the peer-to-peer loan system 100 can allow user 102a, user 102b, and up to any number of users 102n (collectively “users”) to interact using a corresponding number of client devices 104a, 104b, 104n. As further illustrated in FIG. 1, the client devices can communicate with server device(s) 108 via a network 105. In addition, the peer-to-peer loan system 100 can include a payment network 115 communicatively coupled with the server device(s) 108 via the network 105. Although FIG. 1 illustrates a particular arrangement of the users, the client devices, the network 105, the server device(s) 108, and the payment network 115, various additional arrangements are possible. For example, the client devices 104a, 104b, 104n may directly communicate with the server devices 108, bypassing network 105.

As briefly mentioned above, FIG. 1 shows that user 102a and user 102b can use client devices 104a and 104b, respectively, to communicate with one another via the server device(s) 108. For example, user 102a and user 102b can exchange electronic messages containing text, digital content (e.g., audio, images, video), location information, and other forms of data and information. For instance, the user 102a, using client device 104a, can compose a message intended for the user 102b. After composing the message, the user 102a can cause the client device 104a to send the message intended for the user 102b via the network 105 to the server device(s) 108. The server device(s) 108 can identify the user 102b as the intended recipient, and forward the message to the client device 104b associated with the user 102b.

In addition, allowing the users to exchange electronic communications, the peer-to-peer loan system 100 allows the users to send and receive monetary payments to and from one another. In one or more embodiments, the peer-to-peer loan system 100 allows users to define and send a payment message to another user in connection with a loan transaction between users. For instance, the peer-to-peer loan system 100 can allow the user 102a to send a payment to user 102b via the server device(s) 108 and the payment network 115. Likewise, user 102b can receive notice of the payment, and accept or decline the payment. As will be explained in more detail below, the server device(s) 108 can communicate with the payment network 115 to coordinate a transaction that facilitates the payment between the users (i.e., their accounts).

While the peer-to-peer loan system 100 can facilitate a payment between users 102a and 102b, the peer-to-peer loan system 100 can also facilitate a plurality of loan transactions between a requesting user and a plurality of users in connection with a single loan request. For example, the user 102a may send a loan request message to users 102b, 102n, each of which can initiate a loan transaction with the user 102a by sending a payment to the user 102a. Specifically, each user 102b, 102n can accept the loan request and send a payment to the user 102a in separate loan transactions to fulfill the loan request.

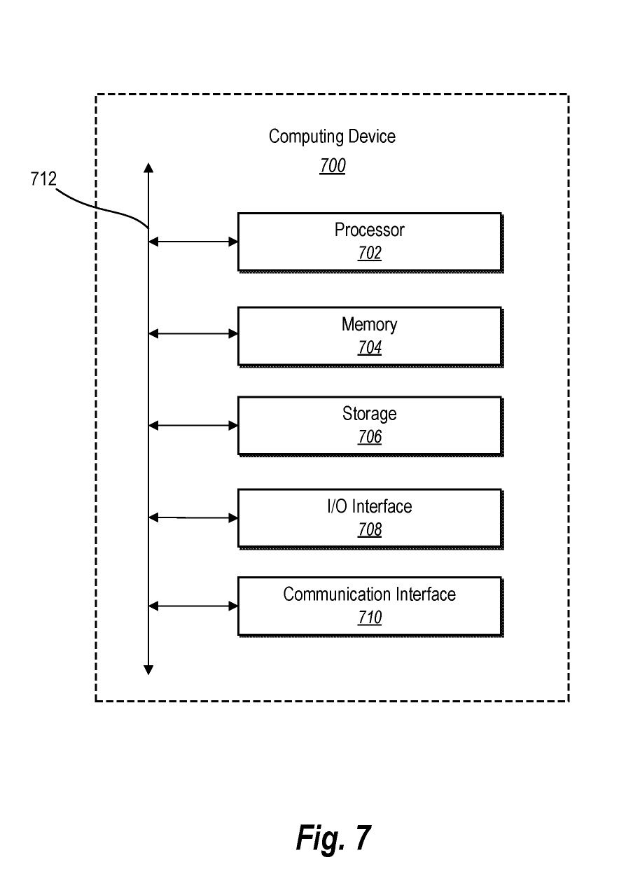

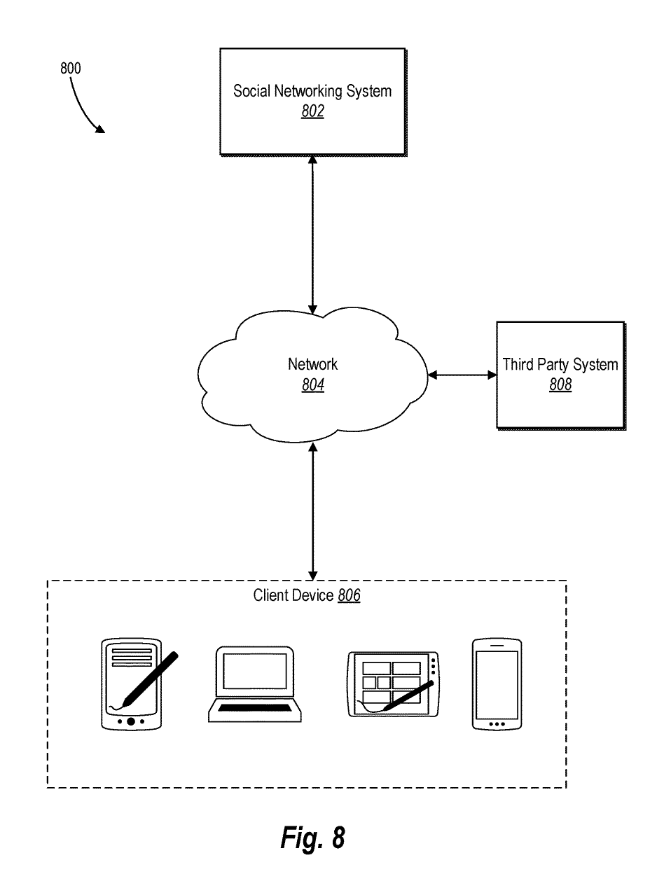

As mentioned above, and as FIG. 1 illustrates, the users 102a and 102b can interact with the client devices 104a and 104b, respectively. Examples of client devices include computing devices such as mobile devices (e.g., smartphones, tablets), laptops, desktops, or any other type of computing device. FIG. 7 and the corresponding description provide additional information regarding computing devices. Moreover, and as mentioned above, the client devices can communicate with each other the through the network 105. In one or more embodiments, the network 105 includes the Internet or World Wide Web. The network, however, can include one or more private and/or public networks that use various communication technologies and protocols, as further described below with reference to FIG. 8.

As briefly discussed above, the peer-to-peer loan system 100 can coordinate the sending and receiving of payments between the users in connection with a loan transaction. For example, a lender user 102b can accept a loan request by composing and sending a payment message to a borrower user 102a in response to a loan request by the borrower user 102a. For instance, the lender user 102b can provide input to via the client device 104b to define the payment method (e.g., the lender user's 102b credit card, debit card, account balance), payment amount, payment currency, payment description, and/or various other payment details. Similarly, the borrower user 102a can send one or more repayment messages to the lender user 102b via the client device 104a, or by way of automatic withdrawals from the borrower user's 102a payment method.

In one or more embodiments, the peer-to-peer loan system 100 can coordinate a transaction between one or more accounts of the lender user 102b and one or more accounts of the borrower user 102a via the payment network 115. For example, in response to receiving a payment message from the lender user 102b, the server device(s) can communicate transaction information to process a payment using one or more components within the payment network 115. Alternatively, or additionally, the peer-to-peer loan system 100 can maintain one or more user accounts directly, and therefore, the peer-to-peer loan system 100 can coordinate a transaction, or a portion of a transaction.

As illustrated in FIG. 1, the payment network 115 includes a payment gateway system 118, a payment processing system 120, a card network system 122 and an issuing bank system 124. In alternative embodiments, however, the payment network 115 can include more or fewer components depending on a particular embodiment of system 100.

In one or more embodiments, for example, the peer-to-peer loan system 100 communicates with the payment network 115 to authorize and process a transaction. For example, the peer-to-peer loan system 100 sends a transaction to the payment gateway system 118, as shown in FIG. 1. Once the payment gateway system 118 receives the transaction, the payment gateway system 118 can send the transaction to the processor (e.g., payment processing system 120) used by a payment recipient user's acquiring bank. Based on the method of the payment (e.g., sender user's account), the payment processing system 120 can transmit the transaction to an appropriate card network system 122. In many instances, the card network system 122 then sends the transaction to an issuing bank system 124.

The issuing bank system 124 either approves or declines the transaction, and sends the decision back to the card network system 122. The card network 122 then sends the decision to the payment processing system 120. The payment processing system 120 can then forward the decision to the payment gateway system 118, and in one or more embodiments, the payment gateway system 118 can maintain the details related to the transaction and the decision. The payment processing system 120 also sends the decision to the peer-to-peer loan system 100.

In addition to authorizing a transaction, the payment network 115 can also perform settlement tasks. For example, the peer-to-peer loan system 100 can coordinate with the payment gateway system 118 to submit a daily settlement batch including one or more captured transactions to an acquiring bank via the acquiring bank's preferred payment processing system 120. The payment processing system 120 then sends the settlement batch to a server of the acquiring bank (not illustrated), which records a deposit in the amount of each transaction within the settlement batch to an account associated with a payment recipient user.

The acquiring bank can then send a funding request in satisfaction of the deposit amount to the payment processing system 120, which passes the funding request to the appropriate card network system 122. The card network system 122 then sends the funding request to the issuing bank system 124. The issuing bank system 124 can post the transaction to the sender user's account and pass a release of the funds to the card network system 122, which are then passed to the payment processing system 120, and then the acquiring bank. Additional details relating to the specific systems, methods, components and process of system 100 are described below.

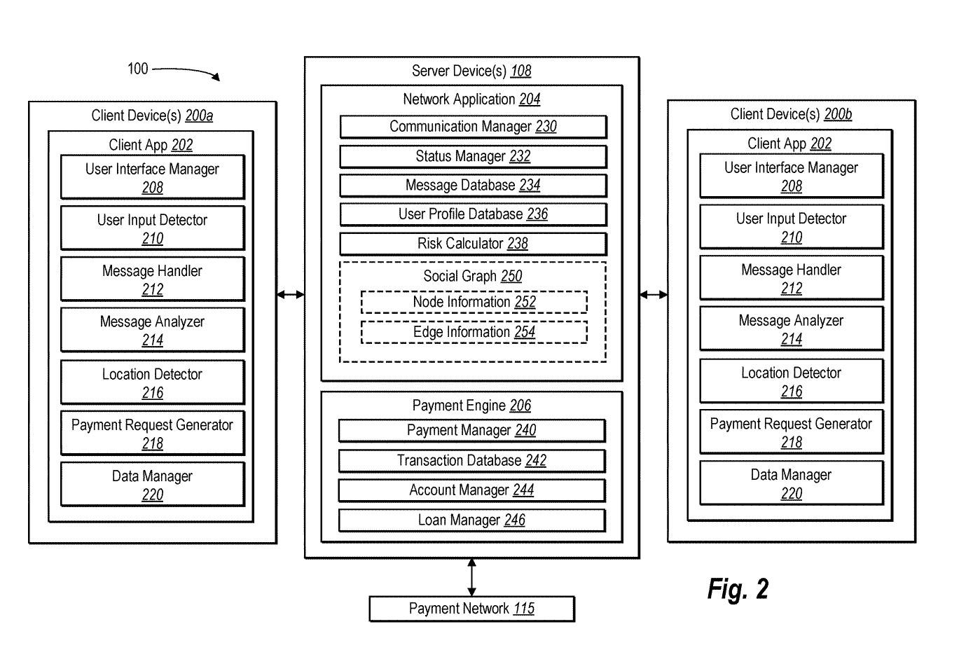

FIG. 2 illustrates a schematic diagram illustrating additional details of the peer-to-peer loan system 100. As shown, the peer-to-peer loan system 100 can include client devices 200a, 200b, server device(s) 108, and payment network 115. In general, the peer-to-peer loan system 100 can allow a user of the client device 200a to send a payment to or receive a payment from a user of client device 200b. Additionally, the system can allow the user of the client device 200a to exchange messages with a user of the client device 200b.

As shown, the peer-to-peer loan system 100 can include various components on the client devices 200a, 200b and the server device(s) 108. For example, FIG. 2 illustrates that the client devices 200a, 200b can each include a client application 202 (e.g., a messaging application) with various components and the server device(s) 108 can include a network application 204 and a payment engine 206 with various components. The components of the client applications 202, the network application 204, and the payment engine 206 can work together to allow the users to send payments, receive payments, and exchange messages as described in greater detail below.

As shown, the client application 202 can include a user interface manager 208, a user input detector 210, a messaging handler 212, a message analyzer 214, a location detector 216, a payment request generator 218, and a data manager 220. FIG. 2 illustrates that the network application 204 can include a communication manager 230, a status manager 232, a message database 234, a profile database 236, and a risk calculator 238. As described below, the network application 204 can also optionally include a social graph 250, which includes node information 252 and edge information 254. FIG. 2 also illustrates that the payment engine 206 can include a payment manager 240, a transaction database 242, an account manager 244, and a loan manager.

Each of the components 208-220, 230-246, 252, and 254 can communicate with each other using any suitable communication technologies. It will be recognized that although components 208-220, 230-246, 252, and 254 are shown to be separate in FIG. 2, any of components 208-220, 230-246, 252, and 254 may be combined into fewer components, such as into a single facility or module, or divided into more components as may serve a particular embodiment. While FIG. 2 describes certain components as part of the client applications 202 and other components as part of the network application 204, the present disclosure is not so limited. In alternative embodiments, one or more of the components shown as part of the client application 202 can be part of the network application 204 or vice versa. Similarly, one or more components shown as part of the network application 204 can be part of the payment engine 206 or vice versa.

The components 208-220, 230-246, 252, and 254 can comprise software, hardware, or both. For example, the components 208-220, 230-246, 252, and 254 can comprise computer instructions stored on a non-transitory computer-readable storage medium and executable by at least one processor of the client devices 200a, 200b or the server device(s) 108. When executed by the at least one processor, the computer-executable instructions can cause the client device(s) 200a, 200b or the server device(s) 108 to perform the methods and processes described herein. The components 208-220, 230-246, 252, and 254 can comprise hardware, such as a special purpose processing device to perform a certain function or group of functions. Additionally, or alternatively, the components 208-220, 230-246, 252, and 254 can comprise a combination of computer-executable instructions and hardware.

In one or more embodiments, the client application 202 can be a native application installed on one of the client devices 200a, 200b. For example, client application 202 may be a mobile application that installs and runs on a mobile device, such as a smart phone or a tablet. Alternatively, the client application 202 can be a desktop application, widget, or other form of a native computer program. Alternatively, the client application 202 may be a remote application that the client device accesses. For example, the client application 202 may be a web application that is executed within a web browser of the client device.

As mentioned above, and as shown in FIG. 2, the client application 202 can include a user interface manager 208. The user interface manager 208 can provide, manage, and/or control a graphical user interface (or simply “user interface”) that allows a user to compose, view, and send messages as well as send payments. For example, the user interface manager 208 can provide a user interface that facilitates the composition of a message, such as an instant message. Likewise, the user interface manager 208 can provide a user interface that displays messages received from other users.

More specifically, the user interface manager 208 may facilitate the display of a user interface (e.g., by way of a display device associated with the client device 200a, 200b). For example, the user interface may be composed of a plurality of graphical components, objects, and/or elements that allow a user to compose, send and receive messages or payments. More particularly, the user interface manager 208 may direct the client device 200a, 200b to display a group of graphical components, objects and/or elements that enable a user to view a messaging thread.

In addition, the user interface manager 208 may direct the client device 200a, 200b to display a one or more graphical objects or elements that facilitate user input for composing and sending a message. To illustrate, the user interface manager 208 may provide a user interface that allows a user to provide user input to the client application 202. For example, the user interface manager 208 can provide one or more user interfaces that allow a user to input one or more types of content into a message. As used herein, “content” refers to any data or information to be included as part of a message. For example, the term “content” will be used herein to generally describe, text, images, digital media, files, location information, payment information and any other data that can be included as part of a message.

As discussed above, one example of content that can be included in a message is a loan request from a borrower user (or simply “borrower”) to a potential lender user (or simply “potential lender”). In one or more embodiments, the user interface manager 208 can provide a user interface to allow a user to easily and efficiently define and send a loan request to one or more other potential lenders. For example, the user interface manager 208 can provide one or more input fields and/or one or more user selectable elements with which a user can interact to create and send a loan request message. Similarly, the user interface manager 208 can allow a potential lender to create and send a loan acceptance message with a payment as part of a loan transaction.

In addition to the forgoing, the user interface manager 208 can receive instructions or communications from one or more components of the client application 202 to display updated message information, updated status of a payment, updated status of a loan request, and/or updated available actions. The user interface manager 208 can update an available option based on whether a particular option is available at a particular point within the transaction process. The user interface manager 208 can add, remove, and/or update various other selectable actions within the sender and/or receiver status messages, as will be discussed below.

The user interface manager 208 can facilitate the input of text or other data to be included in an electronic communication or message. For example, the user interface manager 208 can provide a user interface that includes a keyboard. A user can interact with the keyboard using one or more touch gestures to select text to be included in an electronic communication. For example, a user can use the keyboard to enter a message to accompany and/or describe one or more other content items in an electronic communication. In addition to text, the user interface, including the keyboard interface, can facilitate the input of various other characters, symbols, icons, or other character information.

As further illustrated in FIG. 2, the client application 202 can include a user input detector 210. In one or more embodiments, the user input detector 210 can detect, receive, and/or facilitate user input in any suitable manner. In some examples, the user input detector 210 can detect one or more user interactions with respect to the user interface. As referred to herein, a “user interaction” means a single interaction, or combination of interactions, received from a user by way of one or more input devices.

For example, user input detector 210 can detect a user interaction from a keyboard, mouse, touch pad, touchscreen, and/or any other input device. In the event the client device 200a, 200b includes a touchscreen, the user input detector 210 can detect one or more touch gestures (e.g., swipe gestures, tap gestures, pinch gestures, or reverse pinch gestures) from a user that forms a user interaction. In some examples, a user can provide the touch gestures in relation to and/or directed at one or more graphical objects or graphical elements of a user interface.

The user input detector 210 may additionally, or alternatively, receive data representative of a user interaction. For example, user input detector 210 may receive one or more user configurable parameters from a user, one or more user commands from the user, and/or any other suitable user input. The user input detector 210 may receive input data from one or more components of the client application 202, from the storage on the client device 200a, 200b, or from one or more remote locations (e.g., the network application 204).

The client application 202 can perform one or more functions in response to the user input detector 210 detecting user input and/or receiving other data. Generally, a user can control, navigate within, and otherwise use the client application 202 by providing one or more user inputs that the user input detector 210 can detect. For example, in response to the user input detector 210 detecting user input, one or more components of the client application 202 allow a user to select a recipient for a message, compose a message, select content to include in a message, and/or send a message to the recipient. In addition, in response to the user input detector 210 detecting user input, one or more components of the client application 202 allow a user to navigate through one or more user interfaces to review received messages, contacts, loan history, etc.

In one or more embodiments, in response to the user input detector 210 detecting one or more user inputs, the client application 202 can allow the user to create a loan request to send to one or more other users. For example, a user wanting to send a loan request can interact with a loan request element provided on a menu within a user interface. Upon detecting the user interaction with the loan request element, the user input detector 210 can cause the user interface manager 208 to provide a user interface for creating a loan request message. Therefore, in response to the user input detector 210 detecting one or more user inputs, the client application 202 can allow a user to create a customized loan request message that defines a loan request to be sent to a potential lender, as will further be described below. Similarly, the input detector 210 can detect user input from the potential lender to initiate a loan transaction for a particular loan request.

As further illustrated in FIG. 2, the client application 202 can include a message handler 210 that manages messages provided to or sent from the client application 202. For example, the message handler 210 can interact with the user interface manager 208 and the user input detector 210 to coordinate the sending and receiving of messages using the client application 202. The message handler 210 may direct the sending and receiving of messages to and from the network application 204 over the course of an electronic messaging session among a plurality of participants. The message handler 210 may organize incoming and outgoing messages and direct the user interface manager 208 to display messages.

In one or more embodiments, the message handler 210 can facilitate receiving and sending data via the client application 202. In particular, message handler 210 can facilitate sending and receiving messages. For example, the message handler 210 can package content to be included in a message and format the message in any necessary form that is able to be sent through one or more communication channels and using an appropriate communication protocol, as described herein. To illustrate, the message handler 210 can attach a loan request with corresponding loan terms to a message to send to the server device(s) 108 for distribution to one or more other client devices. Likewise, the message handler 210 can process messages the client device 204 receives from other users.

In addition to providing communication functions for the client application 202, the message handler 210 can provide access to message data. For example, the message handler 210 can access data that represents a list of contacts, or one or more groups of contacts, to include and recipients to a message. To illustrate, the message handler 210 can obtain and provide data representing a contact list to the user interface manager 208 to allow the user to search and browse a contact list, and ultimately select an individual contact or group of contacts to include as recipients of a message. In one or more embodiments, a social-networking system can maintain remote contact list data (e.g., a “friends list”), and the message handler 210 can access the contact list data on the social-networking system for use within the client application 202.

The message handler 210 can also provide access to other local or remote data that the client application 202 can use to compose, send and receive messages. For instance, the message handler 210 can obtain access to files, images, audio, video and other content that a user can include in a message. Moreover, the message handler 210 can provide access to one or more functions of the client device to provide the user the ability to capture or create content to include within a message. For example, the message handler 210 can activate a camera, a microphone, or other function that allows the user to capture content to include in a message.

In addition, the message handler 210 can facilitate the sending of a payment associated with a loan request. In particular, FIG. 2 illustrates that the client application 202 can include a payment request generator 218 that can generate a payment request that the message handler 210 can send to the network application 204 to initiate a payment process/transaction. For example, upon a sender selecting a payment element on a user interface, the payment request generator 218 can create a data package that includes payment information received from the sender. A payment request can include an indication of an amount of money to be sent as part of the payment transaction as well as any necessary information to allow the network application to perform a payment transaction. According to one or more embodiments, the message handler 210 can communicate with the network application 204 directly and/or via the queue manager 246, as described in more detail below.

In one or more embodiments, the payment request generator 218 can create a data package that includes the payment amount, one or more sender identifiers, one or more recipient identifiers, one or more payment methods or sender account information, authorization information, currency information, a message or payment description, and/or any other data that may be helpful to facilitating a payment form the sender to the recipient. Alternatively, a payment request can identify a recipient, an amount of a payment, and an offline reference that allows the client device 200a of a sender user (e.g., a lender or a borrower) to resolve inconsistencies in data sent and received. The payment request generator 218 can pass the payment request (e.g., the data package that includes the payment information) to the message handler 210 to send to the network application 204.

The payment request generator 218 can also obtain payment information from various sources. For example, the payment request generator 218 can obtain payment information directly from the sender via the user input detector 210. Additionally, or alternatively, the payment request generator can gain access to payment information maintained on the client device 200a, 200b by the data manager 220. For example, the client application 202 can allow a sender to input and save various payment methods and/or identify a default payment method, default currency, and otherwise specify other user preferences related to sending and/or receiving a payment.

The payment request generator 218 may also facilitate formatting of messages based on input from the user via the client application 202. Specifically, the payment request generator 218 can facilitate formatting payment requests according to the corresponding payment method. For example, the payment request generator 218 can determine that a user has input a request to pay a co-user in a debit transaction and format of the payment request to the co-user accordingly. In one or more examples, the payment request generator 218 can determine that the payment request should be formatted in a particular format based on payment information or payment credentials associated with the payment transaction or based on a specific selection by the sending user.

In one or more embodiments, the payment request generator 218 can access and provide a token within a payment request. The token can reference a payment credential stored by the network application 204. For example, the payment request generator 218 can retrieve a token to include in, or with, the payment request that verifies the sender and/or sender client device 104a as authorized to make the payment using a payment credential stored by the network application 204.

As mentioned above, the client application 202 can further include a message analyzer 214. The message analyzer 214 can analyze messages sent from and received by the client application 202 for events or attachments. In one or more embodiments, the message analyzer 214 can identify events from contextual content in the exchanged messages. In one or more additional embodiments, the message analyzer 214 can identify a loan request based on an attachment in a message, the loan request containing information about a requested loan transaction.

The client application 202 can further include a location detector 216. The location detector 216 can access or identify a location of the client device 104a, 104b based on GPS information from the client device 200a, 200b, cell tower triangulation, WIFI received signal strength indication, WIFI wireless fingerprinting, radio-frequency identification, near-field communication, by analyzing messages, or based on data from other sources. The location detector 216 can then provide the location of the client device 200a, 200b to the message analyzer 214 or the network application 204. Additionally, the location detector 216 can receive indications of the location of other client devices from the network application 204 and provide them to the message analyzer 214.

As discussed above, the client device 200a can include a data manager 220, as illustrated in FIG. 2. The data manager 220 can maintain message data representative of data used in connection with composing, sending, and receiving messages between a user and one or more other users. For example, message data can include message logs, contact lists, content, past communications, past payment transaction, past loan transactions, and other similar types of data that the client application 202 can use in connection with providing the ability for users to communicate using the client application 202.

The data manager 220 may also maintain payment data representative of information used to generate payment requests. For example, payment data may include a payment method data (i.e., a credential) and/or account data (e.g., bank or credit card account data). Furthermore, payment data can include payment preferences (e.g., a default payment method). In general, payment data can include any data that the payment request generator 218 can use in connection with generating a payment.

As briefly mentioned above, in addition to the client devices 200a, 200b, the peer-to-peer loan system 100 can further include a network application 204 that is implemented in whole or in part on the server device(s) 108. In one or more embodiments of the present disclosure, the network application 204 comprises a social-networking system (such as but not limited to FACEBOOK™), but in other embodiments the network application 204 may comprise another type of application, including but not limited to an e-mail application, search engine application, banking application, or any number of other application types that utilizes user accounts.

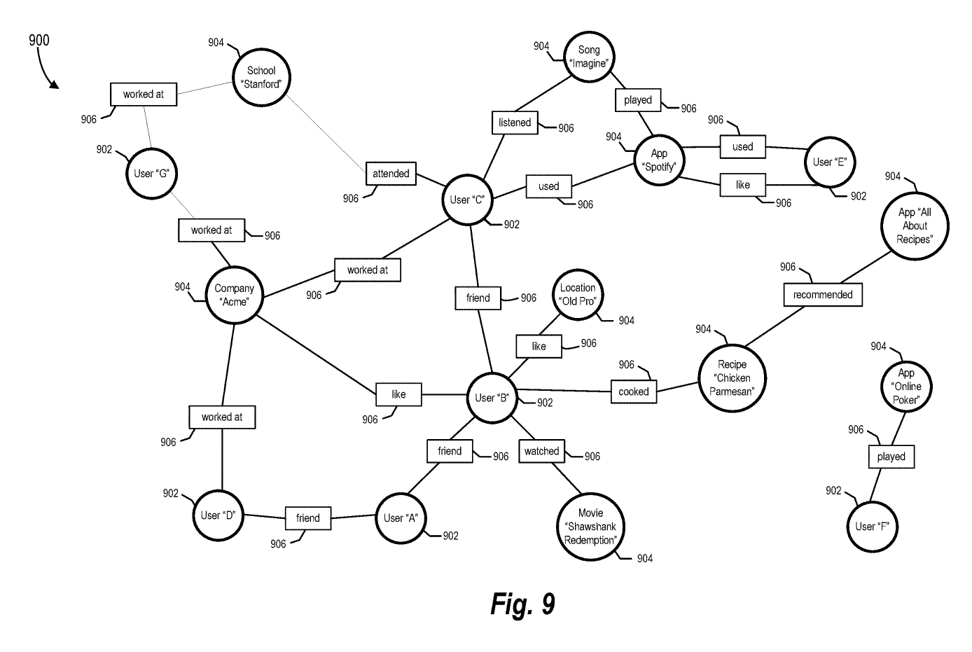

In one or more embodiments where the network application 204 comprises a social-networking system, the network application 204 may include a social graph 250 for representing and analyzing a plurality of users and concepts. Node storage 252 of the social graph 250 can store node information comprising nodes for users, nodes for concepts, nodes for transactions, and nodes for items. Edge storage 254 of the social graph 250 can store edge information comprising relationships between nodes and/or actions occurring within the social-networking system. Further detail regarding social-networking systems, social graphs, edges, and nodes is presented below with respect to FIG. 9.

The communication manager 230 can process messages received from client applications 202. For example, the communication manager 230 can interact with a message handler 206 of a client application 202. The communication manager 230 can act as a director for messages sent back and forth among users in an electronic messaging thread. The communication manager 230 may receive a message from client application 202, detect the intended recipient of the message, and send the message to the client application 202 (or device) associated with the intended recipient. One will appreciate that the communication manager 230 can direct a message for a recipient to multiple client devices associated with the recipient (i.e., each device upon which the user has installed a version of the client application 202).

Additionally, the communication manager 230 can also re-format or otherwise modify the content or format of a message based on the messaging protocol used by a destination communication device or a type. As such, in one or more embodiments the peer-to-peer loan system 100 can allow participants using different communication platforms to exchange messages. For example, the communication manager 230 can receive a message in a first protocol (SMS, IM, XMPP, APNS, etc.), re-format the message into a second protocol, and send the reformatted message to the intended recipient(s).

The status manager 232 can track the status of users of the client applications 202 and/or the client devices 200a, 200b. For example, the status manager 232 can identify when a user is logged into the client application 202, when a user is active on the client application 202, when a client device 200a, 200b associated with a user or user account is online or active. The status manager 232 can send indications (such as push notifications) to the client application 202 to notify the client application 202 of the status of users, device, messages, or payments. The user interface manager 208 can add, modify, or otherwise change or update status notifications based on indications received from the status manager 232. For example, the status manager 232 can send an indication to the client application 202 indicating that another user has accessed a message, received a payment, sent a payment, is active, a device or device type a co-user is active on (e.g., mobile vs. web), etc. The user interface manager 208 in turn an update a user interface to notify a user of the status.

The network application 204 may also include a message database 234. The message database 234 can maintain message data representative of content of messages from electronic messaging sessions among a plurality of participants. The message database 234 may maintain status data representative of the information mentioned above that the status manager 232 tracks. The message database 234 can thus provide an archive of messaging threads, which the network application 204 can provide to a user on demand or once a user logs into the client application 202 using a new computing device.

As mentioned previously, the server device(s) 108 can include a payment engine 206 having a payment manager 240. The payment manager 240 of FIG. 2 can integrate the sending and receiving of payment requests and initiate payment transactions, and may employ one or more application programming interfaces (APIs). For example, upon the communication manager 230 receiving a payment request, the communication manager 230 can send any payment details to the payment manager 240. The payment manager 240 can then use the payment details retrieved from the payment request to initiate a payment transaction using the payment network 115.

According to one or more embodiments, the peer-to-peer loan system 100 can maintain the payment engine 206 separate from the network application 204. For example, the peer-to-peer loan system 100 can implement payment processes associated with the payment engine 206 separately from at least some of the functionality of the network application 204 (e.g., using a messaging database for recovery). To illustrate, the peer-to-peer loan system 100 can implement the functionality of the payment engine 206 on a first group of one or more servers and the functionality of the network application 204 on a second group of one or more servers. Implementing functionality of the payment engine 206 and the network application on separate servers can allow the peer-to-peer loan system 100 to ensure that at least some of the financial information associated with the users is maintained apart from the network application 204 to comply with Payment Card Industry (PCI) standards. Alternative configurations of servers and/or software than those described herein may also allow the peer-to-peer loan system 100 to comply with PCI standards.

The payment manager 240 can coordinate a transaction corresponding to a payment defined in a payment request. As generally explained above, the payment manager 240 can coordinate a transaction via the payment network 115 that corresponds to a payment request, monitor the status of the transaction, and provide status information regarding the transaction. More specifically, the payment network 115 can authorize a transaction, fund a transaction, and/or settle an individual transaction or batch of transactions as described above with reference to FIG. 1. In one or more embodiments, the payment manager 240 can use one or more application programming interfaces (API) to communicate relevant information with the payment network 115.

In additional or alternative embodiments, the client application 202 on the client device 200a can cause the client device 200a to send a payment request and/or messages associated with the payment request to the network application 204 and the payment engine 206 in parallel. In particular, when the client application 202 receives a selection by the user to pay an amount to a co-user in connection with a loan transaction, the client application 202 can cause the client device 200a to send a payment request to the first network application 204 and to the payment engine 206. Thus, the network application 204 can process the payment request while the payment engine 206 is also processing the payment transaction associated with the payment request. In alternative embodiments, the client device 200a can send messages to one or more servers associated with the network application 204, which can then forward the messages to the payment engine 206, or vice versa.

To complete a transaction, the payment manager 240 can access or obtain a payment credential for the recipient (such as deposit account information, debit card, credit card, gift card, electronic wallet). The payment manager 240 can obtain a recipient's payment credential (e.g., a debit card for receiving substantially instant payments) using a variety of methods. In one example embodiment, a recipient can register one or more deposit accounts or other payment credentials with the network application 204. Upon a user registering a deposit account or other payment credential, the user profile database 236 can maintain the payment credential.

After the payment manager 240 receives the payment information, the payment manager 240 can identify the recipient. The payment manager 240 can lookup the recipient in the user profile database 236 to determine if the recipient has registered a payment credential. At this point, the payment manager 240 can initiate the transaction.

In the event that the recipient's user profile does not include a payment credential, the payment manager 240 can direct the communication manager 230 to send the recipient a message prompting the recipient to provide a payment credential. The message may prompt the recipient to register a payment credential by providing one or more interactive fields that allows the recipient to provide payment credential details. Additionally, or alternatively, upon determining that a recipient does not have a registered payment credential, the payment manager 240 can generate a temporary deposit account. In particular, the payment manager 240 can generate an account number and associate the account number with the recipient's user profile. In one or more embodiments, the recipient may already have a temporary account, and therefore, the payment manager 240 can use the previously created temporary account to complete the transaction. In particular, the temporary account allows the payment manager 240 to proceed immediately to process a transaction without delaying the payment process from the perspective of either the sender or the recipient.

The account manager 244 can manage one or more temporary accounts in connection with the networking application. For example, upon completion of the payment, the payment manager 240 can deposit the payment amount to a temporary account. In one or more embodiments, the payment manager 240 can cause the communication manager 230 to send the recipient a message indicating that the payment manager 240 has transferred the money to the recipient's payment credential. For example, if the recipient has already registered a debit account, the payment manager 240 can transfer the money to the registered debit account in a substantially instant payment transaction. Alternatively, if the recipient does not want to register a deposit account, the message system can provide the recipient instructions to withdraw the money from the temporary account.

In addition to coordinating a transaction via the payment network 115, the payment manager 240 can also coordinate a transaction with respect to one or more system user accounts. In one or more embodiments, the network application 204 can support user cash accounts, such as gift card accounts, cash card accounts, or similar types of user accounts. The sender can specify the sender's user cash account as the method of payment, and likewise, the recipient can set the recipient's user cash account as the registered deposit account. Therefore, in at least one or more embodiments, the entire transaction, or substantially the entire transaction, can be processed within the network application 204.

In one or more embodiments, the peer-to-peer loan system 100 can also allow a recipient to register a debit card account as a payment credential to receive funds. In order to send funds to a user's debit card, the payment manager 240 can send a request to credit a payment amount to a recipient's debit card account.

The payment manager 240 of FIG. 2 may perform various functions with relation to coordinating the information received from the communication manger 230 to request and accept payment requests, and to coordinate the payment process. For example, the payment manager 240 can create and store payment credentials. More specifically, a user (e.g., senders and recipients) may already have accounts with the network application, and thus already be registered users, or may still set up an account. In one embodiment, at least some of the users can also be members of a social-networking system and already have identifiers (“IDs”) and user profiles associated with social-networking accounts that are also used when messaging using the peer-to-peer loan system 100. Alternatively, other users may not be members of the social-networking system and can create an account to become a registered member of the peer-to-peer loan system 100. In this example, the payment manager 240 can receive date from these users (via the client application 202) and create an account, and then create a unique ID and user payment profile for these users, which will be referenced later during the payment process. In some cases, the payment manager 240 may also augment user profiles of previous social-networking users to include payment profile features that may have been absent.

In setting up or augmenting the account, a user can submit one or more payment credentials, such as a credit card, a debit card, a deposit account or other bank accounts, gift card accounts, store credit accounts, etc. When adding methods of payment, the peer-to-peer loan system 100 can request that users submit card and/or account numbers, expiration dates, security codes, transfer or routing identification numbers, and bank information used for money transfers. The user can also create an authorization code such as a personal identification number (PIN), or use a security code of a credit card, e.g., when providing only a single payment method, or provide some other authorization code. The user can also select a default method of payment.

The user payment profiles stored by the user profile database 236, accordingly, can include user (or group) IDs created uniquely for each registered user (whether as a social-networking user and/or as a messaging user). The user profile database 236 can provide storage for payment credentials of users of the network application 204. For example, the user can create an “account” with the network application 204, which allows a user to provide the payment information to the network application 204. The network application 204 can then save that payment information in the user profile database 236. In one or more embodiments user profile database 236 can store in relation to the user one or more of: a first name, a middle name, a last name, a payment card number (e.g., a credit card, debit card), an expiration date (year and/or month) of the payment card, a card security code of the payment card (e.g., a Card Verification Value (CVV or CVV2)), a billing address (including street name, house number, city, state or province, zip code, country, etc.) associated with the payment card, a phone number associated with the payment card, one or more shipping addresses (including similar fields as the billing address). When the payment card comprises a debit card, the profile storage module can also store a personal identification number (PIN) for the debit card. In an embodiment where the network application 204 comprises a social-networking system, the payment information stored in the user profile database 236 may be associated with a node of the node storage 252 that represents the user.

In one or more additional embodiments, the payment manager 240 can communicate with the risk calculator 238 to determine a risk associated with a sender, a recipient, and/or a particular payment transaction. Specifically, the risk calculator 238 can determine whether the sender/recipient is a fraudster based on information associated with the sender/recipient in order to prevent fraudulent payment transactions. For example, the risk calculator 238 can determine the likelihood of fraudulent activity based on activity or information associated with the sender/recipient in connection with the network application. Determining a risk associated with users involved in payment transactions can also be useful in identifying one or more potential lenders for a particular loan request by a user.

For example, in one or more embodiments, the network application 204 can determine whether a risk associated with the sender or the recipient satisfies a predetermined threshold. In particular, the network application 204 can determine whether the sender or the recipient (i.e., the lender or borrower depending on the transaction) is a fraudster (e.g., a scam account or software posing as a real person) based on a “realness” score. For example, if the risk associated with the sender is below a predetermined threshold (i.e., a high risk level), the network application 204 can determine that the sender is likely a fraudster and notify the payment engine 206 that the sender is a fraudster. If the sender has a high-risk level, the payment engine 206 can stop a payment transaction between the sender and the recipient. Similarly, if the risk associated with the recipient is below a predetermined threshold, the network application 204 can determine that the recipient is likely a fraudster and notify the payment engine 206 that the recipient is a fraudster.

To illustrate, the network application 204 can determine a realness score for a user based on whether the user has been tagged has been tagged in media posted to the social networking system by one or more co-users, whether co-users of the user recognized the user's previous one or more birthdays (i.e., wished the user a “happy birthday”), the number or volume of messages exchanged between the user and co-users of the user via the network application 204, whether co-users of the user have indicated agreement or solidarity (i.e., “liked”) with posts made by the user, and/or whether co-users of the user have commented on posts made by the user. Additionally, or alternatively, the network application 204 can determine whether the user has been a member of a social networking system for a predetermined amount of time, lives in a pre-approved origination location, has a predetermined level of social network activity with a destination location, has a threshold realness score, etc. In another example, the network application 204 can determine a risk for a user based on the relationship between the user and a co-user, including whether the user and the co-user are friends on a social networking system, are within a number of degrees of separation, etc. Additionally, the network application 204 can use information about the payment transaction to determine whether the payment transaction is fraudulent or erroneous, such as based on the payment amount (e.g., the payment amount includes an unrealistic amount).

In additional embodiments, after determining a risk associated with the sender and/or recipient, the network application 204 can perform one or more actions in association with the risk. Specifically, the network application 204 can perform an action that allows the network application 204 to verify the identity of the user. For example, the network application 204 can request information from the user that indicates the user is who the user purports to be. To illustrate, the network application 204 can request a password entry, a number of digits of a registered payment credential for the user, a personal security question, an upload of a visual identification (e.g., a photo), or other identification mechanism based on the risk level or realness score of the user.

In additional or alternative embodiments, the network application 204 can automatically perform one or more actions with respect to the payment request or a payment transaction in response to determining a risk level of the user. Specifically, the network application 204 can perform an action that affects the payment request or a corresponding payment transaction between the sender and the recipient without requesting additional information from the user. For example, the network application 204 can allow the payment transaction, hold the payment transaction pending for review (e.g., by a bank of the user's payment credential), block the payment transaction, disable the user's account, or process the transaction without using an intermediate account (e.g., directly from the sender's account to the recipient's account).

In any event, upon receipt of a payment request from a sender, the payment manager 240 can detect the user (or group) ID of the sender and retrieve the payment profile for that user (or entity). The payment manager 240 can then generate a transaction package (e.g., a “payment drone”) that includes a transaction ID associated with a payment amount, the sender, and the recipient. The transaction ID can help the peer-to-peer loan system 100 track money from the sender's account, within the system in a temporary or intermediate account, and to the recipient's account. In some instances, the peer-to-peer loan system 100 can provide users access to the transaction ID to follow the movement of money during a corresponding payment transaction.

The transaction package can also include a default payment method, and related information, unless the sender selected to send a payment to the recipient with an alternative payment method, in which case the transaction package can include payment information for the alternative payment method. The payment manager 240 may then send the transaction package to the payment network 115 to initiate the payment authorization process.

The payment manager 240 can perform various other additional steps and methods in order to effectively manage the payment process. In one or more embodiments, for example, upon receiving a payment request the payment manager 240 can generate a transaction identifier (or simply “transaction ID”) and associate the transaction identifier with the payment request and/or the payment information within the payment request. For instance, upon generating a transaction ID, the payment manager 240 can send the transaction ID and the payment information to the transaction database 242. The transaction database 242 can include a data table or similar data matrix that stores transaction information according to transaction ID.

The transaction database 242 of FIG. 2 can provide storage for each transaction (such as in the form of a graph object), attempted or completed, the transaction ID, a date, an amount of the transaction, the payment method used, associated messages interchanged between sender and recipient related to the transaction, and any other information gathered on the transaction. The transaction database 242 can also store loan transaction information, such as loan requests associated with a user, the loan terms for a particular loan transaction, and number of payments or repayments performed and/or yet to be performed. With this information, the payment manager 240 can provide, upon request, a summary of one or more transactions to users as a history of payments requested, payments declined and payments completed.

In one or more embodiments, after a transaction ID is associated with a particular payment request, the transaction ID can be included or embedded within substantially all communications within the peer-to-peer loan system 100 relating to the particular payment. As such, the transaction ID allows the payment manager 240 to manage and process a large number of payments in an organized fashion. For example, the payment manager 240 can include instructions to include the transaction ID in any information sent to the client devices 200a, 200b. In return, the messaging handlers 210 can also include the transaction ID in any information sent from the client devices 200a, 200b to allow the payment manager 240 to efficiently and reliably identify a particular transaction to which the information corresponds.

In one or more embodiments, the transaction ID can be associated with one or more sender identifiers, recipient identifiers, thread identifiers (e.g., identifying a messaging thread between the sender and the recipient), payment amounts, payment methods (e.g., sender accounts), deposit methods (e.g., recipient accounts), transaction history, current transaction status, as well as other transaction information. In one or more embodiments, the transaction database 242 maintains the transaction information in the form of one or more graph objects that are updated with any updates or actions with respect to a transaction.

Also, as previously mentioned, the account manager 244 of the payment engine 206 can maintain one or more intermediate or temporary accounts. The temporary accounts can function as a type of “hot account” that provides funding for a deposit to be made into a recipient account prior to the settlement or actual funding of the payment from the sender's account. For instance, with some payment methods, the funding of the payment may take several hours or even days for money to be debited from the sender's account. However, a payment authorization request can verify and reserve funds to satisfy a payment. Thus, upon receiving a successful response from a payment authorization request, the payment manager 240 can fund the payment amount from a temporary account to provide a shorter time for the payment to arrive in the recipient's account. Once the payment funds from the sender's account, the temporary account is renewed for the amount of the payment.

As mentioned, the payment engine 206 can also include a loan manager 246. The loan manager 246 can manage loan transactions and loan requests associated with each user of a social networking system. In particular, the loan manager 246 can identify one or more potential lenders from a plurality of users of the social networking system for a particular loan request. The loan manager 246 can use information stored in the user profile database, message database, transaction database, and/or any other information to determine whether a specific user is a potential lender for a particular loan request. Thus, the loan manager 246 can identify users who are most likely to loan money to a given user based on user relationships, interactions by the users, messages composed by users, and payment/loan histories of the users to identify potential lenders.

The loan manager 246 can also manage other aspects of loan transactions, including providing suggestions for or setting the loan terms for the loan transactions. Specifically, the loan manager 246 can use information stored at the network application 204 or the payment engine 206 to identify favorable loan terms for a borrower and/or potential lenders. For example, suggested loan terms can increase the likelihood of potential lenders loaning money to the borrower and of the borrower repaying the potential lenders. Additionally, or alternatively, the loan manager 246 can allow the users to set the loan terms for a loan transaction.

The loan manager 246 can also manage the progress of loan transactions. For example, after a user and one or more co-users of the social networking system initiate one or more loan transactions, the loan manager 246 can track the progress of the loan transactions based on the loan terms set by the user and one or more co-users. To illustrate, after a user and a co-user initiate a loan transaction, the loan manager 246 can determine when to prompt or cause the user to repay the co-user in one or more repayment transactions according to the loan terms. Thus, the loan manager 246 can automatically manage one or more operations or aspects of the loan transaction to prove an easy and simple loan transaction between the user and co-user.

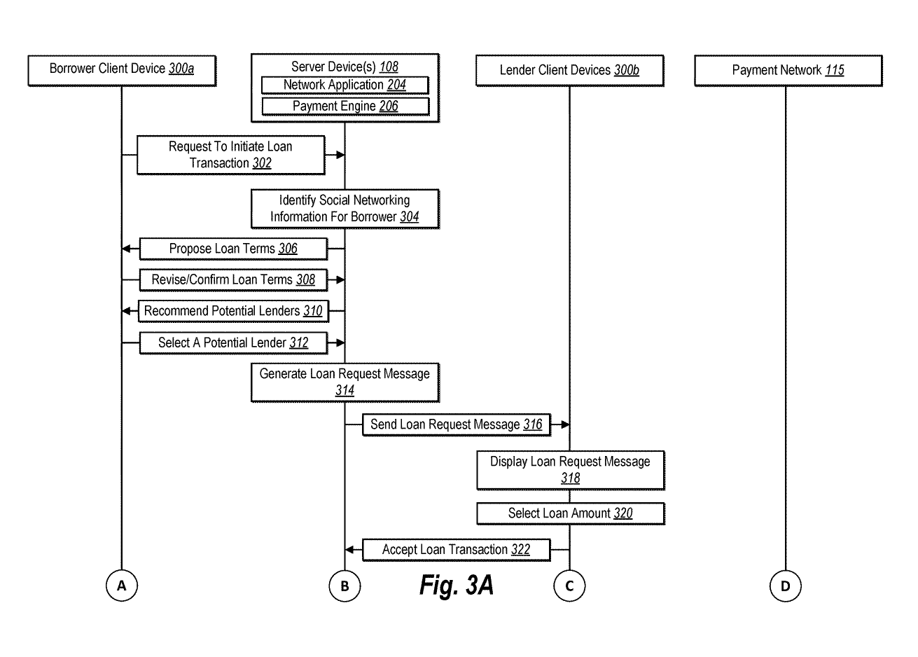

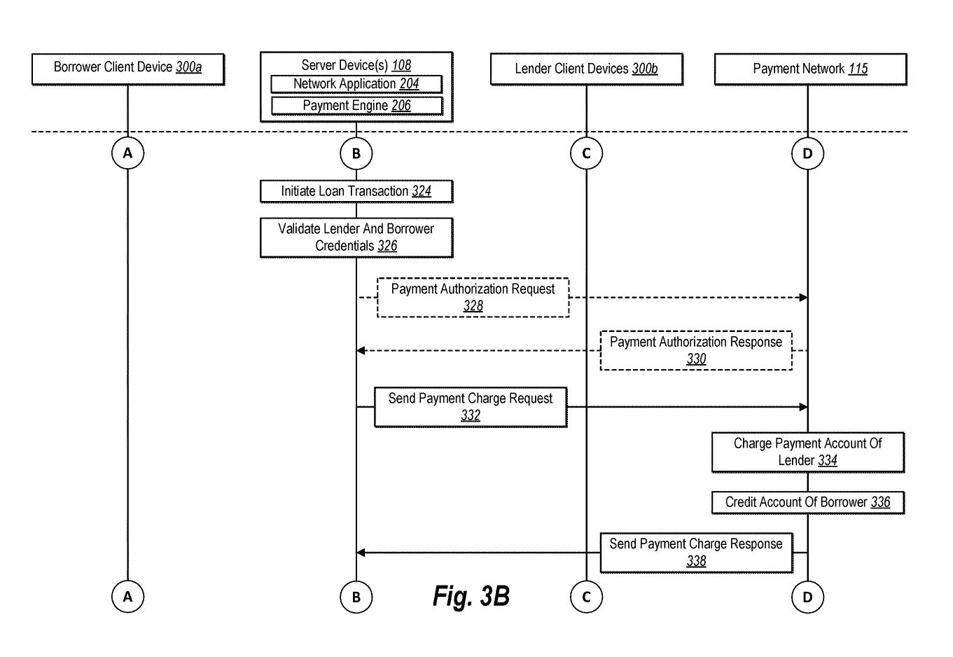

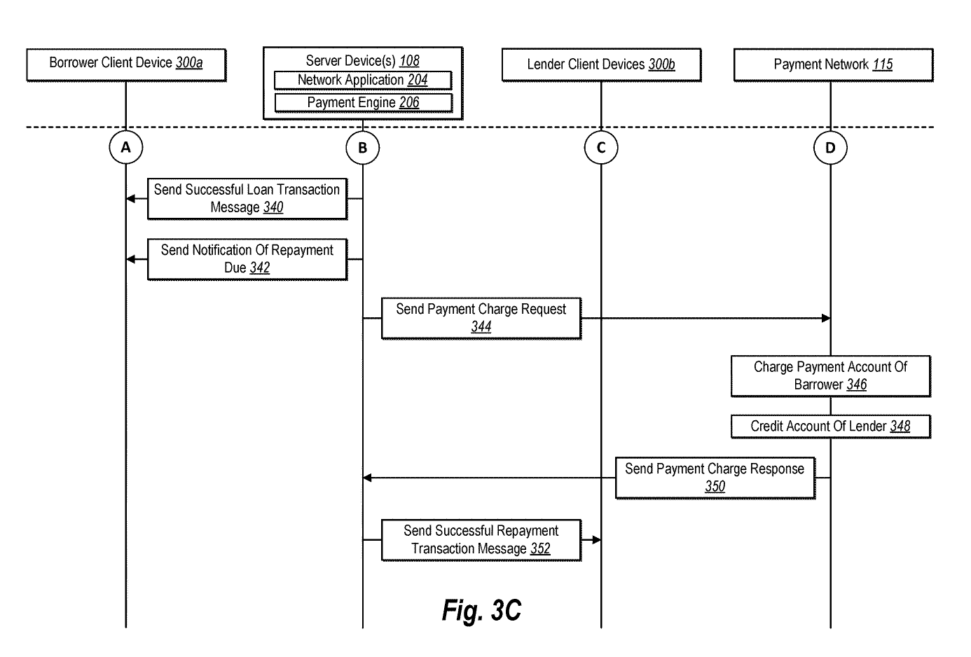

As discussed, the systems and components discussed above with reference to FIGS. 1-2 can allow users of a social networking system to easily, effectively, and securely engage in loan transactions via a peer-to-peer loan system 100. FIGS. 3A-3C illustrate example process diagrams of one or more example embodiments of processes implemented by the peer-to-peer loan system 100 discussed above. Consistent with peer-to-peer loan system 100 illustrated in FIGS. 1 and 2, FIGS. 3A-3C illustrate (according to a sequence flow of operations) a borrower client device(s) 300a with a client application 202, a lender client device(s) 300b with a client application 202, server device(s) 108 that support a network application 204 and a payment engine 206, and a payment network 115.

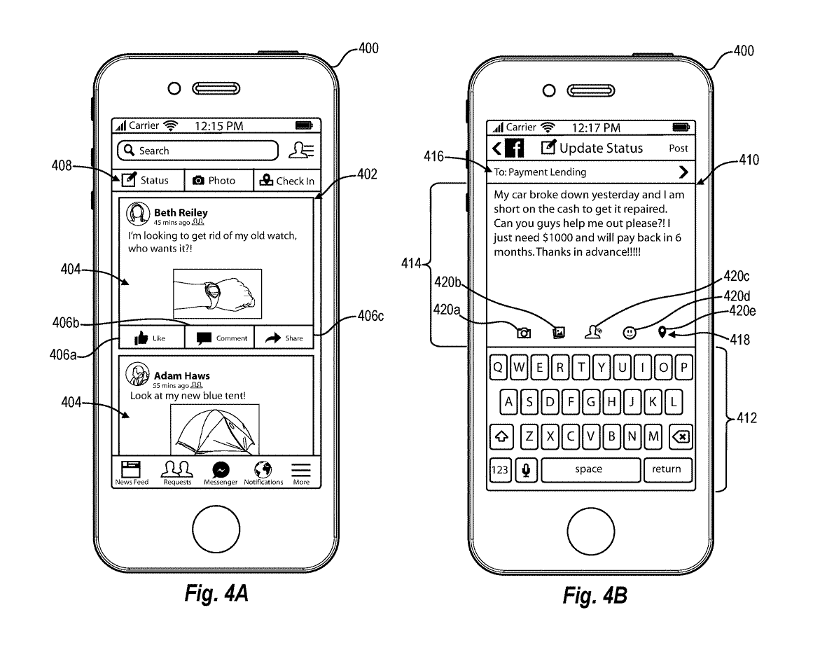

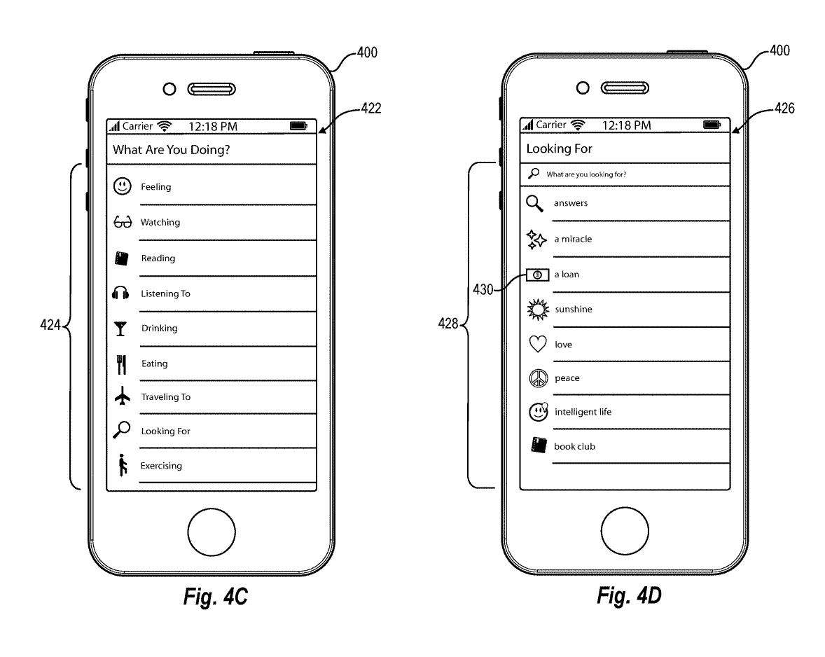

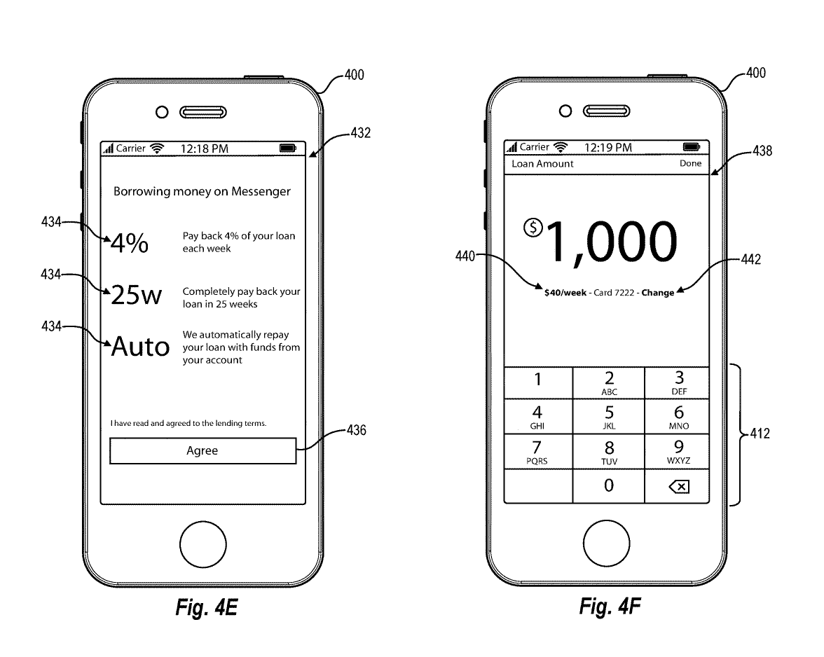

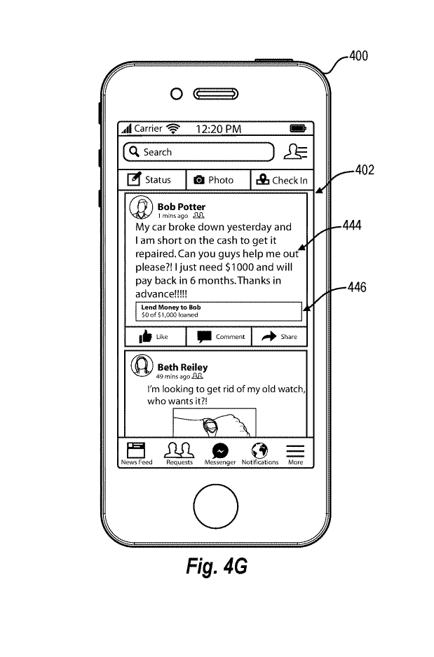

In one or more embodiments, a process for a user (“borrower”) requesting and initiating a loan transaction with another user (“lender”) can begin with the borrower associated with the borrower client device 300a requesting 302 to initiate a loan transaction with one or more potential lenders. For example, the borrower can access one or more user interfaces that allow the borrower to select an option to initiate a loan transaction. To illustrate, selecting an option to initiate a loan transaction can cause the client application to open a message user interface that allows the user to input information about the loan transaction. For instance, the borrower can describe a purpose of the loan transaction, a loan amount, and/or a proposed repayment schedule (e.g., as shown in FIG. 4B), as well as provide any other information about the loan transaction that might be useful to potential lenders.

In response to the request to initiate a loan transaction, the server device(s) 108 can identify 304 social networking information for the borrower. Specifically, the server device(s) 108 can identify information that the social networking system has maintained that will allow the server device(s) 108 to perform one or more operations related to the loan request. For example, the server device(s) 108 can identify other users that have a relationship with the borrower (e.g., “friends”) or who are within a certain number of relationship degrees from the borrower (e.g., “friends of friends”), loan history for the borrower and other users, payment history for the borrower and other users, messaging history for the borrower and other users, and/or other information as may serve a particular embodiment.

Based on the identified social networking information, the server device(s) 108 can optionally perform a risk check to determine a risk of the borrower. For example, the network application 204 can use information associated with the borrower, the borrower's contacts and/or a relationship between the borrower and the borrower's contacts to determine whether to allow the borrower to request a loan or how risky a potential loan might be.

For example, the network application 204 can determine how risky a potential borrower/loan is based on information stored by the social graph 250. In one or more embodiments, the network application 204 can determine how risky a potential borrower/loan is based on social, economic, or demographic information maintained by the network application. Such social, economic, or demographic information can comprise one or more of a records or past loans, purchases, or other financial transactions conducted by the borrower via the network application, an address of the borrower, friends of the borrower, vouching of the borrower by other users of the network application 204, etc.

The network application 204 can determine a risk associated with the borrower and notify the payment engine 206 of the risk to allow the payment engine 206 to determine whether to process loan transactions associated with the borrower. In various embodiments, the risk check may occur at any time or at multiple times during the loan transaction process before transferring money to the borrower, such as while money is in an intermediate or temporary account.

In one or more embodiments, the server device(s) 108 can use the identified information to propose 306 loan terms for the loan transaction. For example, the server device(s) can propose loan terms including, but not limited to, an interest rate, a repayment deadline, and whether repayments will occur automatically (e.g., through automatic withdrawal) or manually (e.g., requiring the borrower to manually initiate repayment transactions). The server device(s) 108 can identify which loan terms to propose based on various criteria associated with the borrower and/or one or more potential lenders. To illustrate, the server device(s) 108 can propose loan terms based on loan terms of previous loan transactions for the borrower. Alternatively, the server device(s) 108 can propose loan terms that are favorable to the borrower or potential lenders based on a likelihood of repayment by the borrower.

In one or more embodiments, the server device(s) 108 can propose loan terms based on the risk associated with the borrower. For example, the server device(s) can determine that the borrower has a low risk and propose loan terms that correlate to a typical low-risk loan transaction (e.g., low interest rates). In contrast, if the borrower is high risk, the server device(s) 108 can propose loan terms that correlate to a typical high-risk loan transaction (e.g., higher interest rates). Additionally, or alternatively, the server device(s) 108 can place a cap on one or more of the loan terms based on the risk or other criteria, such as placing a cap on the interest rate and/or on the repayment time schedule.

The server device(s) 108 can send the proposed loan terms to the borrower client device 300a for displaying in a user interface of the client application. For instance, the network application 204 can generate a message that includes the proposed loan terms to send to the borrower client device 300a. The borrower client device 300a can display the proposed loan terms in a user interface (e.g., a messaging interface or a notification area) of the client application 202.

In response to receiving and viewing the proposed loan terms, the borrower can revise 308 or confirm the proposed loan terms. Specifically, the borrower can determine whether to accept the proposed loan terms for the requested loan transaction or to modify one or more of the loan terms. For example, the borrower can adjust the interest rate, the repayment time schedule, and/or whether repayment is automatic or manual. The borrower can then cause the borrower client device 300a to send the revised or confirmed loan terms to the server device(s) 108. Alternatively, the borrower can create new loan terms without using proposed loan terms from the server device(s) 108.

At this point or prior, the server device(s) 108 can recommend 310 potential lenders to the borrower. In particular, the server device(s) 108 can identify one or more co-users of the social networking system who are likely to loan money to the borrower. For example, the server device(s) 108 can use the social networking information to determine how likely a co-user is to loan money to the borrower. To illustrate, the server device(s) 108 can calculate a probability that a particular co-user is to loan money to the borrower based on various criteria and compare the probability to a predetermined threshold. If the probability meets the predetermined threshold, the server device(s) 108 can determine that the co-user is a potential lender, and recommends the co-user as a potential lender to the borrower for display at the client application 202.

In one or more embodiments the peer-to-peer loan system 100 identifies potential lenders that are friends of the borrower. One will appreciate in light of the disclosure herein that the friends of the borrower are more likely to lend money to the borrower. Furthermore, the borrower is more likely to repay friends. Thus, the peer-to-peer loan system 100 can recommend one or more friends. Furthermore, the peer-to-peer loan system 100 can identify friends with a strong relationship as defined by the social graph. The peer-to-peer loan system 100 can identify friends with a factual relationship to the borrower (parents, siblings, aunts, uncles, cousins, etc.), friends within whom the borrower often communicates via the network application 204 whether via instant messages, comments on posts, or likes of posts or photos, or other friends likely to lend money to the borrower. In one or more embodiments, the peer-to-peer loan system 100 identifies friends that have lent money to friends in the past or that have borrowed money in the past. In still further embodiments, the peer-to-peer loan system 100 identifies friends of friends of the borrower that are likely to loan money.

The borrower can then select 312 a potential lender for requesting to initiate a loan transaction. Specifically, the borrower can select an option to initiate the loan transaction with the specified potential lender and send the selected potential lender to the server device(s) 108. In one example, recommending a potential lender can cause the borrower client device 300a to pre-populate a recipient field in the messaging user interface in connection with the request to initiate the loan transaction. Alternatively, the borrower can manually select a user as a potential lender in the messaging user interface.

The server device(s) 108 can then generate 314 a loan request message to send to the selected potential lenders. In one or more embodiments, the selected potential lenders can include all of the recommended potential lenders. In one or more other embodiments, the selected potential lenders can include only a portion of the recommended potential lenders, none of the recommended potential lenders, or a mix of the recommended potential lenders and manually selected potential lenders. The loan request message can include information provided by the borrower, as well as user identifiers for each of the potential lenders to which the borrower selected to send the loan request message. According to at least some embodiments, the loan message includes the loan terms and other information about the loan in an attachment to a message composed by the borrower.

After generating the loan request, the server device(s) 108 can send 316 the loan request message to the selected potential lenders including the lender. For example, the server device(s) 108 can send the loan request message to one or more client devices associated with the lender, such as the lender client device 300b. To illustrate, the network application 204 can communicate with the client application 202 at the lender client device 300b to send the loan request message to the lender client device 300b.

The client application 202 of the lender client device 300b can then display 318 the loan request message within a user interface at the lender client device 300b. For example, the client application 202 can display the loan request message in a notification area, a messaging thread, and/or an information feed that includes messages associated with the lender and other users associated with the lender (e.g., “friends” of the lender). Thus, the lender client device 300b can display the information for the requested loan transaction associated with the borrower, including the borrower's name or identity, the requested loan amount, the purpose of the loan request or other information associated with the loan transaction.

According to one or more embodiments, the lender can view the loan message and select 320 a loan amount to loan to the borrower in a loan transaction. In particular, the lender can select the loan amount based on a requested loan amount identified in the loan request message. For example, the lender can select an option in the client application 202 to pay the full requested loan amount to the borrower in a loan transaction between the lender and the borrower. Alternatively, the lender can select to pay a partial amount of the requested loan amount (e.g., the lender can opt to pay $100 of a $1000 requested loan amount) in a loan transaction between the lender and the borrower. Paying a partial amount can allow the borrower to enter into a plurality of loan transactions for the requested loan amount with a plurality of lenders.

In one or more embodiments, after selecting a loan amount, the lender can accept 322 a loan transaction with the borrower. Specifically, the lender can accept the loan transaction by selecting an accept option within a user interface of the client application 202. Accepting the loan transaction can cause the lender client device 300b to send an acceptance message to the network application 204 and/or the payment engine 206 at the server device(s) 108. Accepting the loan transaction can indicate to the network application 204 and the payment engine 206 that the lender is entering into the loan transaction for a specific amount.

Accepting the loan transaction also allows the server device(s) 108 initiate 324 the loan transaction. In particular, the payment engine 206 can initiate the loan transaction by beginning a process to transfer the loan amount associated with the loan transaction from the lender to the borrower. Additionally, the payment engine 206 can also apply the established loan terms to the loan transaction, including setting a repayment schedule and repayment amounts. In one or more embodiments, the server device(s) 108 can also notify the borrower of the accepted loan transaction.

At this point, or before depending upon whether the lender and/or borrower already had a payment credential on file, the network application 204 can perform a validation step to validate 326 the lender and borrower payment credentials. For example, the client application 202 can obtain, identify, or otherwise discover a user identifier for the lender/borrower for the network application 204 as describe above in relation to validating the sender. The client applications 202 on the lender client device 300b and the borrower client device 300a can send the corresponding obfuscated user identifier to the network application 204 in response to initiating the loan transaction. The network application 204 can then verify that the obfuscated user identifiers are valid. This process may serve as the authentication for the lender and the borrower, as the existence of proper obfuscated user identifiers for the network application 204 indicates that the lender/borrower has already been authenticated by the network application 204.

The payment engine 206 can also optionally authorize the payment credential of the lender with the payment network 115. Specifically, the payment engine 206 can send 328 a payment authorization request against the lender's payment credential (e.g., debit card of the lender) for the amount of the payment or another amount (e.g., $0.01 or $100.00) to the payment network 115, which can approve or deny payment authorization. The payment network 115 can then send 330 the payment credential authorization response to the payment engine 206. One will appreciate that the optional authorization request can take place earlier or later in the timeline. In alternative implementations, the payment engine 206 can send an authorization request against the payment credential of the lender for the amount of the payment as part of the payment transaction.

In one or more embodiments, the payment engine 206 can send 332 a payment charge request to the payment network 115 that requests the payment amount be charged to the lender's payment credential. In response to the payment charge request, the payment network 115 can charge 334 the payment credential of the lender, and credit 336 the account of the borrower. The payment network 115 can then send 338 a payment charge response to the payment engine 206 indicating that the payment charge was successful. As shown by FIG. 3B, the peer-to-peer loan system 100 can cause the payment network 115 to directly send money from the payment credential of the lender to the payment credential of the borrower. In other words, the peer-to-peer loan system 100 does not act as an escrow or an actual party to the peer-to-peer loan. As such, the peer-to-peer loan system 100 can facilitate the loan, match borrowers and lenders, provide risk assessments, and facilitate automatic repayment of the loan without being a party to the loan or receiving funds of the loan.

In response to the payment charge response from the payment network 115, the server device(s) 108 can generate and send 340 a successful loan transaction message to the borrower client device 300a. Specifically, the network application 204 can generate a message to inform the borrower that the loan transaction has initiated, and that the lender has initiated a payment transaction to transfer funds to the borrower's payment credential. For example, the network application 204 can send a successful loan transaction message including a notification for displaying within the client application 202 at the borrower client device 300a. Additionally, or alternatively, the network application 204 can send a message that causes the client application 202 to update a loan request message in a messaging thread involving the lender and the borrower to indicate that the loan transaction initiated. In one or more implementations, the network application 204 can also send a successful loan transaction message to the lender indicating that the lender's payment has gone through.

In addition to initiating the loan transaction and notifying the lender and borrower of the initiated loan transaction, the server device(s) can also set up a system by which the borrower can repay the lender. For example, the server device(s) 108 can set up an automatic repayment schedule based on the loan terms for transferring funds from the borrower to the lender in one or more repayment transactions. According to one or more embodiments, the network application 204 can send 342 a notification to the borrower client device 300a to notify the borrower that a repayment is due. To illustrate, the network application 204 can provide a notification to the borrower client device 300a for displaying in a notification area or a messaging thread of the client application 202 when a repayment transaction is scheduled.

According to a repayment schedule for a loan transaction, the server device(s) 108 can automatically process repayment transactions based on the repayment schedule. In particular, the server device(s) 108 can determine that a repayment transaction is scheduled based on the repayment schedule and attempt to transfer funds from the borrower to the lender for a scheduled repayment amount. For example, at the time of the scheduled repayment the payment engine 206 can automatically send 344 a payment charge request to the payment network 115 that requests the payment amount be charged to the borrower's payment credential. In response to the payment charge request, the payment network 115 can charge 346 the payment credential of the borrower, and credit 348 the account of the lender. The payment network 115 can then send 350 a payment charge response to the payment engine 206 indicating that the payment charge was successful. The server device(s) 108 can also send 352 a successful repayment transaction message to the lender client device 300b. In one or more embodiments, the server device(s) 108 can also notify the borrower of the successful transaction message.

Additionally, the server device(s) 108 can automatically apply any loan terms to the repayment transaction according to the loan transaction. For example, the payment engine 206 can automatically apply interest to a repayment amount according to the repayment schedule when transferring funds from the borrower to the lender. Additionally, or alternatively, the payment engine 206 can space out repayments from the borrower to the lender based on the repayment schedule (e.g., on a specific day of each week/month for a specified number of weeks/months).

Alternatively, the server device(s) 108 can allow the borrower to manually initiate a payment transaction according to the repayment schedule. Specifically, the borrower can initiate the payment transaction by selecting an option in the client application 202 to pay an amount to the lender. For example, the borrower can select a message or notification related to a scheduled repayment to open a payment interface. The borrower can then select the amount to pay the lender and send the payment transaction message to the server device(s) 108. The payment engine 206 can then proceed with the payment charge request to the payment network 115 to transfer the repayment amount from the borrower's payment credential to the lender's payment credential.

Although FIGS. 3A-3C illustrate an example loan transaction between a borrower and a single lender, the peer-to-peer loan system 100 can support loan transactions between the borrower and a plurality of lenders associated with a single loan request. Specifically, as mentioned previously, each lender can select to pay a portion of the full requested loan amount in separate one-to-one loan transactions with the borrower. For example, the server device(s) can process each loan payment from the lenders separately and establish separate loan terms for each of the loan transactions, including setting up separate repayment schedules based on the corresponding loan terms for each separate loan transaction. In at least some instances, the loan amounts for all of the loan transactions may sum to equal the full requested loan amount, though the partial amounts may total less than the full requested loan amount.

Additionally, or alternatively, the peer-to-peer loan system 100 can support peer-to-business loans. In particular, the peer-to-peer loan system 100 can allow businesses (e.g., small businesses) or similar entity to request loans from individual co-users of the social networking system. For example, a business can set up an account with the social networking system and interact with other co-users of the social networking system as if the business were an individual user. Thus, the peer-to-peer loan system 100 can allow businesses to initiate peer-to-business loan transactions in which the business receives loans from one or more co-users of the social networking system and repays the loan amounts based on the corresponding loan terms.

In one or more embodiments, the peer-to-peer loan system 100 can also allow one or more vouching users to repay a portion of the loan amount or the entire loan amount to the one or more lenders instead of the borrower. In particular, the peer-to-peer loan system can allow one or more co-users to vouch for the borrower to guarantee at least a portion of the loan amount. For example, by vouching for a borrower, a co-user can indicate to a lender that the co-user will repay a specified amount in case the borrower defaults on the loan transaction. Alternatively, the co-user can guarantee a specified amount regardless of whether the borrower defaults on the loan transaction.

Additionally, or alternatively, the peer-to-peer loan system 100 can allow co-users to informally vouch for the borrower by commenting on a messaging thread associated with the loan request message. According to one or more embodiments, informal vouching users may not be responsible for any portion of the loan amount in case the borrower defaults. Additionally, the peer-to-peer loan system 100 can determine a risk or validity of any vouching users (formal or informal) in conjunction with the loan request to increase security and improve the likelihood that the lenders will receive the agreed upon repayment amount.

In particular, many people in the world, such as in developing or impoverished nations, many not have a credit score or any type of credit history. As such, traditional lenders may find such people as unfit or too risky to lend money. In reality, such potential borrowers may be honest and hardworking but lack the means to establish a credit history. The peer-to-peer loan system 100 can provide a mechanism for such potential borrowers to establish a peer-to-peer lending “credit history.” In particular, the peer-to-peer loan system 100 can track peer-to-peer loans, repayment history, and timeliness and use this information to rate potential borrowers or the risk associated with a potential loan. The peer-to-peer loan system 100 can surface this information (a risk score or a credit worthiness score) in the loan request message 316.

Additionally, or alternatively, the peer-to-peer loan system 100 can provide for an informal vouching that the borrower will repay the loan. For example, the peer-to-peer loan system 100 can identify users that known or have a strong affinity with the borrowers and request that such users vouch for the borrower. When a user vouches for a borrower, the peer-to-peer loan system 100 can add a comment to the loan request message 316 that indicates that the user vouches for the borrower. A plurality of “vouching” comments indicate and encourage potential lenders to loan money to the borrower. Thus, the peer-to-peer loan system 100 can allow users to turn social capital into financial capital.

In one or more embodiments, the peer-to-peer loan system 100 can request users to vouch for a given borrower. For example, the peer-to-peer loan system 100 can identify friends or friends of friends with a large circle of influence or who have a high affinity score with the borrower or a given potential lender send them a message via the network application 204 to vouch for the borrower. Alternatively, the peer-to-peer loan system 100 can allow the borrow to request other users to vouch or them.

According to one or more embodiments, the peer-to-peer loan system 100 can notify the borrower and/or the lender of a missed payment from the borrower to the lender. For example, if the borrower misses a payment, the peer-to-peer loan system 100 can send the borrower and/or the lender a message indicating that the borrower missed a payment. The peer-to-peer loan system 100 can apply penalties to the repayment amount based on the loan terms and/or based on a discussion between the lender and the borrower. For example, the peer-to-peer loan system 100 can automatically initiate a messaging thread between the borrower and the lender to determine how to proceed with the missed payment.

Thus, the peer-to-peer loan system 100 provides a platform which offers a way for a lender to send funds directly to a borrower, but also simultaneously a platform on which the borrower and lender can communicate with about the loan. The peer-to-peer loan system 100 can generate a payment bubble automatically once a week when payments on the loan are made. If the borrower defaults on a payment because there is not enough money in their bank account, the peer-to-peer loan system 100 can send a message via the communications platform to allow the borrower and the lender to discuss late or missed payments and a new repayment schedule if needed.

In at least some implementations, the peer-to-peer loan system 100 can allow the lender to “forgive” the loan to the borrower if the lender so desires, ending the loan transaction between the lender and the borrower. Specifically, the peer-to-peer loan system 100 can provide an option to the lender that allows the lender to terminate the loan transaction. For example, if the lender selects the option to terminate the loan transaction, the peer-to-peer loan system 100 can stop any future automatic attempts to transfer money from the borrower to the lender based on the loan terms and set an owed amount balance to zero.

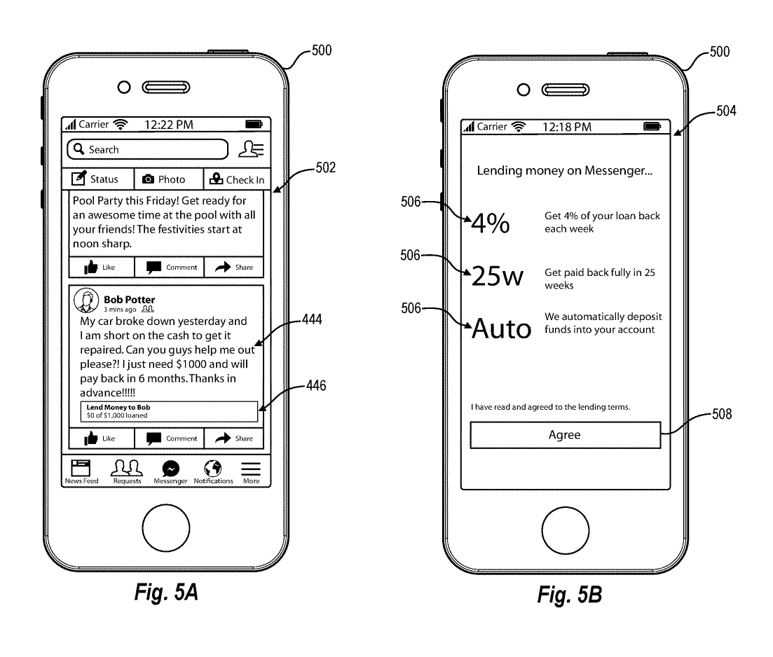

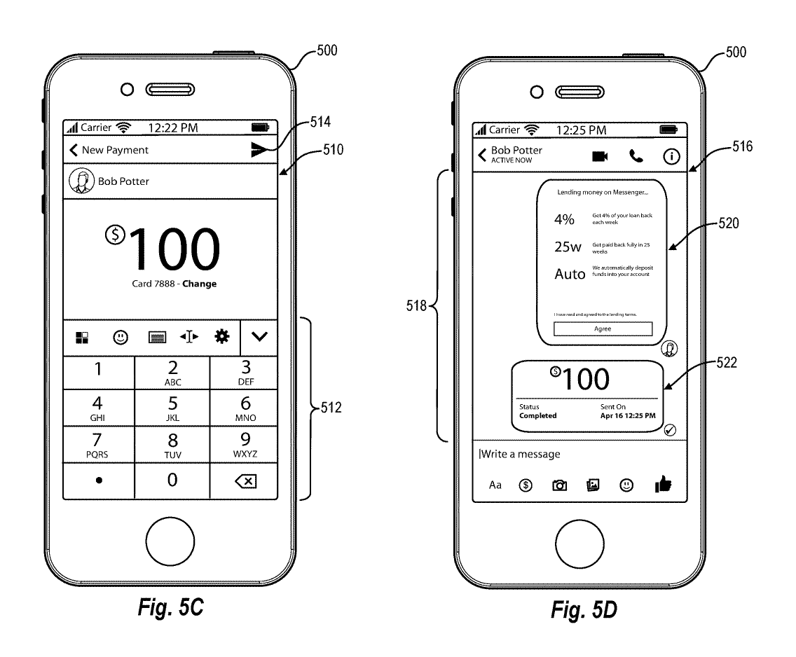

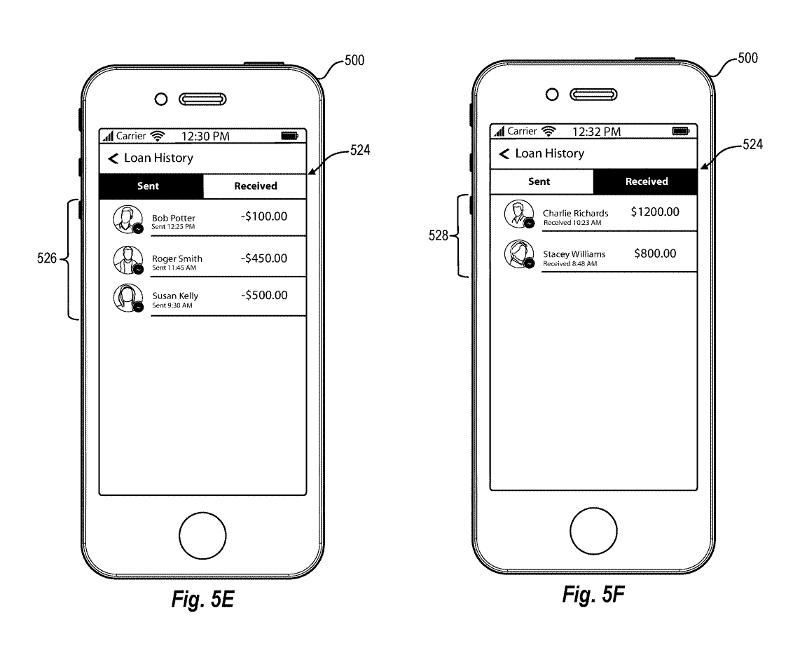

As will be described in more detail below, the components of the peer-to-peer loan system 100 as described with regard to FIGS. 1-2, can provide, along and/or in combination with the other components, one or more graphical user interfaces. In particular, the components can allow a user to interact with a collection of display elements for a variety of purposes. In particular, FIGS. 4A-4G and FIGS. 5A-5D and the description that follows illustrate various example embodiments of the user interfaces and features that allow a user and co-users of a social networking system to enter into peer-to-peer loan transactions.

For example, FIGS. 4A-4G and FIGS. 5A-5D illustrate various views of GUIs provided by the client application to facilitate electronic messaging and sending and receiving payments via loan transactions. FIGS. 4A-4G illustrate a borrower client device 400 that can allow a user (e.g., a borrower) to interact with one or more co-users via the client application in connection with a loan request. FIGS. 5A-5D illustrate a lender client device 500 that can allow a co-user (e.g., a potential lender) to interact with the user via the client application in connection with the loan request. As described in more detail below, the borrower and the potential lender can communicate with each other via the client applications 202 on the respective client devices.

FIGS. 4A-4G and FIGS. 5A-5D illustrate the borrower client device 400 and the lender client device 500 as handheld devices. As used herein, the term “handheld device” refers to a device sized and configured to be held/operated in a single hand of a user. In additional or alternative example, however, any other suitable computing device, such as, but not limited to, a tablet device, a handheld device, larger wireless devices, laptop or desktop computer, a personal-digital assistant device, and/or any other suitable computing device can perform one or more of the processes and/or operations described herein.

With reference to FIGS. 4A-4G, as mentioned, the borrower can interact with display elements in one or more user interfaces of the client application 202 to request a loan from one or more potential lenders associated with the social networking system. FIG. 4A illustrates a message feed user interface 402 (or simply “message feed interface”) of the client application 202. The message feed interface 402 can display a plurality of messages 404 in a “news feed” or other messaging thread view for the borrower in connection with the social networking system. For instance, the message feed interface 402 can display messages composed by the borrower and/or messages composed by co-users of the social networking system. The messages from co-users may be directed specifically to the borrower, or the messages may be indirectly related to the borrower (e.g., by way of the relationships between the co-users and the borrower).

According to one or more embodiments, the client application 202 can sort and display messages 404 in the message feed interface 402 based on various criteria. For example, the client application 202 can communicate with the social networking system to determine whether the borrower has user preferences that determine how messages are displayed in the message feed interface 402. Additionally, the social networking system can promote messages 404 to display in the message feed interface 402 based on how likely each message is to interest the user. The social networking system can also take into account the recency of the messages 404, user interactions with the messages, and/or other criteria to determine in which order to display messages 404 associated with the borrower within the message feed interface 402.

When displaying messages within the message feed interface 402, the client application 202 can display user information for the messages 404. To illustrate, the client application 202 can display an identity of the user (or co-user) who composed a particular message. The client application 202 can also display the identities of one or more co-users who interacted with the message (e.g., users who have “liked” or commented on the messages).

The client application 202 can also display at least a portion of each message 404 in the message feed interface 402. In particular, the client application 202 can identify the content of the messages and summarize the content for display in the message feed interface 402. To illustrate, summarizing the content can include displaying a picture and/or a portion of text associated with the message 404. As described below, the summary for a loan request message can include an explanation by the borrower of the purpose of the requested loan or other information about the requested loan.

In one or more embodiments, the message feed interface 402 also includes a plurality of elements that allow the borrower to interact with messages 404 in the message feed interface 402. For example, the message feed interface 402 can include a “like” element 406a that allows the borrower to “like” a message. The message feed interface 402 can also include a “comment” element 406b that allows the borrower to make a comment on the message. The message feed interface 402 can also include a “share” element 406c that allows the borrower to share the message with other co-users or via other platforms.

According to one or more embodiments, the message feed interface 402 can include an option to create a new message. Specifically, the message feed interface 402 of FIG. 4A includes a “status” option 408 that allows the borrower to open a message interface 410 to create a message and send the message to one or more co-users in the social networking system. When the borrower selects the “status” option 408, the client interface can display the message interface 410, as illustrated in FIG. 4B.

In one or more embodiments, the client application 202 can provide an input area in the message interface 410 that allows the borrower to input information associated with the loan request. Specifically, the input area can include a touchscreen display keyboard 412 in a lower portion of the message interface 410 that the user may utilize to compose a textual message by tapping keys on the keyboard 412. As the borrower types into the keyboard 412, the message interface 410 can display the text in an input field or message area 414 above the keyboard 412 in the message interface 410. To illustrate, FIG. 4B includes a text message that describes that the borrower's car broke down and he needs a loan for $1000 to be repaid in six months. In one or more implementations, the borrower can include additional details or content, such as pictures (e.g., the car that needs repairs) or tagging specific co-users.

According to at least some embodiments, the message interface 410 can also include a recipient field 416. In particular, the recipient field 416 can include one or more potential lenders to which the borrower wants to send the loan request message. As previously mentioned, the peer-to-peer loan system 100 can propose one or more potential lenders to the borrower. For example, the peer-to-peer loan system 100 can send proposed potential lenders and cause the client application 202 to prepopulate the recipient field 416 with the proposed potential lenders. In additional or alternative embodiments, the borrower can modify the recipient field 416 by adding or removing potential lenders to the recipient field 416.

In one or more embodiments, the message interface 410 can also include a message input control toolbar 418 that includes a variety of selectable message input controls that provide a user with various message input options or other options. For example, in FIG. 4B, the message input control toolbar 418 includes a camera viewfinder input control 420a, a multimedia input control 420b, a user tagging control 420c, a symbol control 420d, and a location control 420e. In one or more alternative embodiments, the message input control toolbar 418 may provide the input controls in a different order, may provide other input controls not displayed in FIG. 4B, or may omit one or more of the input controls shown in FIG. 4B.

As will be described below in greater detail, the borrower may interact with any of the input controls in order to compose and send different types of electronic communications. If the borrower interacts with the camera viewfinder input control 420a, the client application 202 can provide a digital camera interface within a portion of the message interface 410 that the user may utilize to capture, send, and add a digital photograph or digital video to the loan request message. If the borrower interacts with the multimedia input control 420b, the client application 202 may provide a multimedia content item display area (e.g., for displaying digital photographs, digital videos, etc.) within a portion of the message interface 410. Likewise, if the borrower interacts with the user tagging control 420c, the client application 202 can allow the borrower to tag one or more users, manually or automatically, within the loan request message. If the borrower interacts with the symbol control 420d, the client application 202 can allow the borrower to input one or more symbols and/or associate other information with the loan request message, such as attaching a loan request to the loan request message. Interacting with the location control 420e can cause the client application 202 to input location information for the borrower in the loan request message.

In one or more embodiments, in response to the borrower selecting the symbol control 420d, the client application 202 can provide a symbol category interface 422, as illustrated in FIG. 4C. The symbol category interface 422 can include a plurality of different symbol categories 424 that organize a plurality of symbols available for inserting into messages. For example, the symbol category interface 422 can include symbol categories 424 including symbols associated with feelings, media (e.g., books, TV, movies, music), food, drinks, travel, user groups/requests, exercise, and/or other categories. Each symbol category 424 may include one or more symbols corresponding to the symbol category 424.

In one or more embodiments, selecting a symbol category opens a symbol list interface 426 with the symbols corresponding to the selected symbol category. FIG. 4D illustrates a symbol category list 428 associated with a “looking for” category. Specifically, the “looking for” category can include symbols for objects or subjects related to user interest groups or concepts that might not fit in other categories. For example, the symbol list interface 426 can display a plurality of symbols including “answers,” “a miracle,” “a loan,” etc. Thus, the symbol category list can provide a loan symbol 430 that the borrower can insert into a message to generate a loan request message.

When the borrower selects the loan symbol 430, the client application can provide a loan terms interface 432, as illustrated in FIG. 4E. In particular, the loan terms interface 432 can allow the borrower to select loan terms for selecting loan terms for a loan request. For example, the loan terms can include a payment amount per period, a repayment schedule (e.g., number of payments and time frame for the payments), and whether the peer-to-peer loan system 100 will automatically withdraw funds from the borrower's account to pay the lender(s). Although FIG. 4E illustrates the loan terms to include a specific set of loan terms, the loan terms can include additional, or alternative, loan terms, as may serve a particular embodiment (e.g., interest rate).

In one or more embodiments, as previously mentioned, the peer-to-peer loan system 100 can propose loan terms to the borrower based on information associated with the borrower. For example, the proposed loan terms can include a proposed payment amount per repayment period, a proposed repayment schedule, and a default setting for repaying the loan automatically or manually. The proposed loan terms can be based on relationship strength between the borrower and one or more potential lenders, the borrower's past loan transactions (e.g., number of loans, amount of loans, previous loan terms), the borrower's past payment transactions (e.g., number of payments made by the borrower, payment amounts), the number of co-users with which the borrower is associated in the social networking system, (e.g., how many “friends” the borrower has), the number of friends of friends of the borrower, and any other information available to the social networking system.

The user can use the proposed loan terms or adjust one or more of the proposed loan terms prior to accepting the loan terms. For example, the loan terms interface 432 can include an edit option (not shown) to allow the borrower to select and modify the loan terms. Alternatively, the loan terms interface 432 can allow the borrower to tap on a term element 434 for one or more of the displayed loan terms in the loan terms interface 432 to modify the selected loan term. To illustrate, selecting a term element 434 for a loan term can cause the client application 202 to display the keyboard 412 or other input element to allow the borrower to enter a new loan term.

Once the borrower has set the loan terms by selecting an “agree” element 436 in the loan terms interface 432, the client application 202 can provide a loan amount interface 438. For example, FIG. 4F illustrates a loan amount interface 438 that allows the borrower to enter a requested loan amount in connection with the loan request. Specifically, the loan amount interface 438 can include a keyboard 412 to allow the borrower to manually select the appropriate amount, though the loan amount interface can include voice controls, slider bars, or other input controls.

Selecting the loan amount can cause the loan amount interface 438 to display an estimated repayment amount 440 for the borrower based on the loan terms and the loan amount. Specifically, the estimated repayment amount 440 can take into account the number of repayment periods, the repayment amount per period, and interest rate (if applicable). To illustrate, FIG. 4F displays an estimated repayment amount 440 of $40 per week for 25 weeks to repay a loan amount of $1000.

In one or more embodiments, the loan amount interface 438 can also include a payment credential option 442 to allow the borrower to confirm or edit a payment credential to associate with the loan request. In particular, the borrower can input a new payment credential or update the payment credential so that any loaned amounts go to the identified payment credential. The loan amount interface 438 can also select a default payment credential for depositing loans.

After entering the loan amount, the client application 202 can attach the loan request to the previously generated message. Additionally, the client application 202 can post the loan request message 444 with a loan request attachment 446 to the borrower's message feed interface 402, as illustrated in FIG. 4G. For example, posting the loan request message 444 can cause the loan request message 444 to appear in the message feed interface 402. The loan request message 444 can include the text and other information about the loan request, such as the attached loan request. In one or more implementations, the loan request message 444 can appear with a summary of the loan terms and the current status of the loan request (e.g., “Loan Money to Bob” and “$0 of $1,000 loaned”).

As mentioned, FIGS. 5A-5F illustrate GUIs on a lender client device 500 by which a lender (or a potential lender) can interact with a loan request message 444 from the borrower. Specifically, when the borrower submits the loan request message 444 to the social networking system, the social networking system can cause the loan request message 444 appear in a message feed interface 502 in the client application 202 at the lender client device 500, as shown in FIG. 5A. In one or more embodiments, the peer-to-peer loan system can cause the loan request message 444 to appear in a message feed for each of the potential lenders listed in the recipient field of the loan request message 444. Alternatively, the peer-to-peer loan system can cause the loan request message 444 to appear as a private message or a notification to the potential lenders.

In one or more embodiments, the lender can interact with the loan request message 444 in a variety of ways. For example, the lender can “like” the message, comment on the message to discuss the loan request (e.g., discuss the loan terms or the purpose of the loan request), share the loan request, or open the loan request message 444 to view more details about the loan request. In one example, the lender can view more details about the loan request by tapping on the loan request message 444 to preview the loan terms or view additional text for the loan request message 444.

In at least some embodiments, selecting the loan request message 444 or the attachment 446 to the loan request message 444 can cause the client application 202 to provide the loan terms interface 504 to the lender. FIG. 5B illustrates the loan terms interface 504 from the perspective of the lender. As illustrated, the loan terms interface 504 can adjust the text in the loan terms interface 504 to include language directed to the lender.

One or more embodiments can allow the lender to adjust one or more of the loan terms for the loan request. For example, the lender can select a term element 506 for a loan term in the loan terms interface 504 and adjust the loan term. After adjusting one or more of the loan terms, the lender can send the proposed adjustments to the borrower as a comment to the loan request message 444 or as a new message. Alternatively, the lender can discuss the loan terms with the borrower in a comments section of the loan request message 444, and the borrower can send a new loan request message 444 to the lender.

Once the lender agrees with the loan terms, the lender can select an “agree” element 508 to accept the loan terms and proceed to a loan amount interface 510 in the client application 202. FIG. 5C illustrates an embodiment of the loan amount interface 510 at the lender client device 500. The loan amount interface 510 can allow the lender to select a loan amount to provide to the borrower. For example, the loan amount interface 510 can include a keyboard 512 or other input control that allows the lender to specify whether the lender is loaning the full requested loan amount or a partial loan amount. To illustrate, in the embodiment of FIG. 5C, the lender has opted to loan $100 out of the requested $1000.

In addition to selecting the loan amount, the lender can select a payment credential for transferring funds to the borrower. In one or more embodiments, the loan amount interface 510 can provide a default payment credential based on a previously entered payment credential or based on a user preference for the lender. Additionally, or alternatively, the lender can update the information for the payment credential, or use a different payment credential. Alternatively, the lender can enter a new payment credential not previously used by the lender.

The lender can then select a “send” element 514 to initiate the loan transaction with the borrower. Specifically, selecting the “send” element 514 can cause the client application 202 to communicate with the server device(s) 108 to transfer funds from the lender to the borrower. For example, transferring funds from the lender to the borrower can include communicating with the payment network 115 to transfer the entered loan amount from the lender's payment credential to the borrower's payment credential, as previously described.

In one or more embodiments, initiating the loan transaction can cause the peer-to-peer loan system 100 to provide a message to the borrower and the lender. For example, FIG. 5D illustrates a messaging interface 516 of the client application 202 at the lender client device 500. In one or more embodiments, initiating the payment transaction can also initiate a messaging thread 518 between the lender and the borrower. To illustrate, initiating the payment transaction, or performing another operation such as selecting the loan request message 444 or the attachment 446, can cause the lender client device 500 to open a separate messaging application. For example, the separate messaging application can include the messaging interface 516 to allow the lender to communicate with the borrower with one or more instant messages. The messaging interface of FIG. 5D includes a snapshot 520 of the loan terms associated with the loan request message 444 within a messaging thread 518 between the borrower and the lender.

After initiating the loan transaction, the peer-to-peer loan system 100 can provide a payment transaction message 522 within the messaging thread. For example, the payment transaction message 522 can include information related to the payment transaction to transfer funds from the lender to the borrower. To illustrate, the payment transaction message 522 can appear as a message from the lender to the borrower, and can include the loan amount from the lender.

In one or more embodiments, the payment transaction message 522 can also include a current status of the payment transaction. In particular, the current status of the payment transaction can indicate whether the payment transaction is pending, processing, or complete, along with a timestamp of the most recent status change. In at least some instances, the payment transaction can take only a few seconds to change from pending to complete. At other times, however, the payment transaction can take longer to complete, for example, if the lender does not have a network connection at the time that the lender attempts to initiate the transaction. In another example, the payment transaction may fail due to the lender canceling the payment transaction or due to insufficient funds in the lender's payment credential.

According to one or more embodiments, a user can access a loan history within the client application 202. For example, FIGS. 5E and 5F illustrate a loan history interface 524 including a loan history for the lender. Specifically, the client application 202 can provide the loan history interface 524 that displays previous loan transactions in which the lender has been involved. FIG. 5E illustrates a history of loan transactions 526 in which the lender loaned money to users as part of loan requests by the users. FIG. 5F illustrates a history of loan transactions 528 in which the lender received money from other users as part of a loan request by the lender.

As previously mentioned, the social networking system can maintain loan histories for users in determining whether a particular co-user would be a potential lender for a given loan request. In particular, the peer-to-peer loan system 100 can use the information maintained by the social networking system to identify co-users who are most likely to loan money to a user. The peer-to-peer loan system 100 can use information for a particular user including, but not limited to, the number of loans the user has given/received, the number of times the user has missed a payment, the amounts that the user has loaned/received, the number of co-users who have vouched for the user, and the relationships between the user and other co-users. The loan histories can also include information about each separate payment transaction, including each repayment transaction by the borrower to each lender.

Additionally, the peer-to-peer loan system 100 can allow lenders to provide information about loan transactions to credit bureaus. For example, allowing lenders to provide information about loan transactions to credit bureaus allows the borrowers to have the loan transaction count toward their credit score. Thus, users who do not have little to not credit history can establish a credit history. Similarly, users with low credit scores can potentially improve their credit scores by engaging in peer-to-peer loan transactions with co-users of the social networking system.

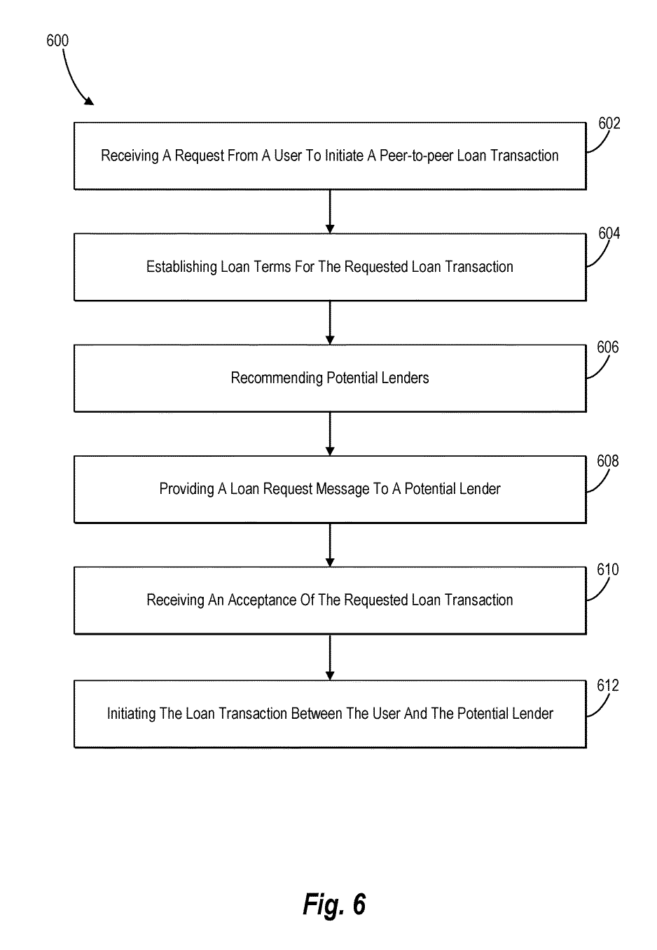

FIGS. 1-5F, the corresponding text, and the examples, provide a number of different systems and devices for sending and receiving payments using an integrated electronic payment and messaging system. In addition to the foregoing, embodiments can be described in terms of flowcharts comprising acts and steps in a method for accomplishing a particular result. For example, FIG. 6 illustrates a flowchart of an exemplary method in accordance with one or more embodiments.

FIG. 6 illustrates a flowchart of a method 400 of enabling peer-to-peer loan transactions. The method 600 includes an act 602 of receiving a request from a user to initiate a peer-to-peer loan transaction. For example, act 604 can involve receiving a request to initiate a loan transaction between the user and one or more co-users of a social networking system.

The method 600 also includes an act 604 of establishing loan terms. For example, act 604 involves establishing loan terms for the requested loan transaction. To illustrate, act 604 can involve establishing a repayment plan comprising one or more repayment amounts of the loan amount to the potential lender according to a repayment schedule. Act 604 can also involve establishing an interest amount associated with the repayment schedule. Act 604 can further involve establishing whether to automatically withdraw funds from a payment credential of the user based on the repayment schedule.

Act 604 can involve recommending default loan terms based on the information maintained by the social networking system. Additionally, or alternatively, act 604 can involve receiving loan terms selected by the user.

The method 600 further includes an act 606 of recommending potential lenders. For example, act 606 involves recommending to the user one or more potential lenders from a plurality of co-users of the social networking system likely to loan money to the user based on information maintained by the social networking system. To illustrate, the information maintained by the social networking system comprises information about previous loan transactions and payment transactions for the plurality of co-users of the social networking system. Act 606 can further involve receiving a selection of one or more of the recommended potential lenders by the user.

Additionally, the method 600 includes an act 608 of providing a loan request message to a potential lender. For example, act 608 involves providing a loan request message to a potential lender of the one or more potential lenders. To illustrate, the loan request message can include a message in a messaging feed interface of a messaging application. Alternatively, the loan request message can include a message in a messaging thread involving the user and the potential lender. Additionally, the loan request message can include a loan attachment containing the loan terms and a requested loan amount for the requested loan transaction.

The method 600 also includes an act 610 of receiving an acceptance of the requested loan transaction. For example, act 610 involves receiving an acceptance of the requested loan transaction for a first loan amount by the potential lender. To illustrate, act 610 can involve receiving the acceptance of the requested loan transaction for a first partial amount of a full requested amount associated with the requested loan transaction. Act 610 can also involve receiving a selection of the first loan amount by the potential lender. In one or more embodiments, the first loan amount can be a partial amount of a full requested loan amount in the loan request message.

The method 600 includes an act 612 of initiating the loan transaction between the user and the potential lender. For example, act 612 involves initiating the loan transaction between the user and the potential lender according to the established loan terms by transferring the loan amount from a payment credential of the potential lender to a payment credential of the user. Act 612 can further involve notifying the user of the initiated loan transaction.

The method 600 can further include an act of receiving, from a vouching co-user of the social networking system, a guarantee of the loan transaction to repay the loan amount to the potential lender. The method 600 can include an act of determining that the user defaults on one or more repayments of the loan amount to the potential lender. The method 600 can also include an act of transferring a default amount from a payment credential of the vouching co-user to the payment credential of the potential lender.

The method 600 can also include an act of providing the loan request message to a second potential lender of the one or more potential lenders. Additionally, the method 600 can include an act of receiving an acceptance of the requested loan transaction for a second loan amount by the second potential lender, wherein the second loan amount is a second partial amount of the full requested amount. The method 600 can also include an act of initiating a second loan transaction between the user and the second potential lender according to the established loan terms by transferring the second loan amount from a payment credential of the second potential lender to a payment credential of the user.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 that may be configured to perform one or more of the processes described above. One will appreciate that one or more computing devices such as the computing device 700 may implement the message system 100. As shown by FIG. 7, the computing device 700 can comprise a processor 702, a memory 704, a storage device 706, an I/O interface 708, and a communication interface 710, which may be communicatively coupled by way of a communication infrastructure 712. While an exemplary computing device 700 is shown in FIG. 7, the components illustrated in FIG. 7 are not intended to be limiting. Additional or alternative components may be used in other embodiments. Furthermore, in certain embodiments, the computing device 700 can include fewer components than those shown in FIG. 7. Components of the computing device 700 shown in FIG. 7 will now be described in additional detail.

In one or more embodiments, the processor 702 includes hardware for executing instructions, such as those making up a computer program. As an example and not by way of limitation, to execute instructions, the processor 702 may retrieve (or fetch) the instructions from an internal register, an internal cache, the memory 704, or the storage device 706 and decode and execute them. In one or more embodiments, the processor 702 may include one or more internal caches for data, instructions, or addresses. As an example and not by way of limitation, the processor 702 may include one or more instruction caches, one or more data caches, and one or more translation lookaside buffers (TLBs). Instructions in the instruction caches may be copies of instructions in the memory 704 or the storage 906.

The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The storage device 706 includes storage for storing data or instructions. As an example and not by way of limitation, storage device 706 can comprise a non-transitory storage medium described above. The storage device 706 may include a hard disk drive (HDD), a floppy disk drive, flash memory, an optical disc, a magneto-optical disc, magnetic tape, or a Universal Serial Bus (USB) drive or a combination of two or more of these. The storage device 706 may include removable or non-removable (or fixed) media, where appropriate. The storage device 706 may be internal or external to the computing device 700. In one or more embodiments, the storage device 706 is non-volatile, solid-state memory. In other embodiments, the storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 708 allows a user to provide input to, receive output from, and otherwise transfer data to and receive data from computing device 700. The I/O interface 708 may include a mouse, a keypad or a keyboard, a touchscreen, a camera, an optical scanner, network interface, modem, other known I/O devices or a combination of such I/O interfaces. The I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 708 is configured to provide graphical data to a display for presentation to a user. The graphical data may be representative of one or more graphical user interfaces and/or any other graphical content as may serve a particular implementation.

The communication interface 710 can include hardware, software, or both. In any event, the communication interface 710 can provide one or more interfaces for communication (such as, for example, packet-based communication) between the computing device 700 and one or more other computing devices or networks. As an example and not by way of limitation, the communication interface 710 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MIMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 712 may include hardware, software, or both that couples components of the computing device 700 to each other. As an example and not by way of limitation, the communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the peer-to-peer loan system 100 can comprise a social-networking system. A social-networking system may enable its users (such as persons or organizations) to interact with the system and with each other. As mentioned above, the peer-to-peer loan system 100 can comprise a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, on-line calendars and event organization, messaging, games, or advertisements) to facilitate social interaction between or among users. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings.

FIG. 8 illustrates an example network environment 800 of a social-networking system. Network environment 800 includes a client system 806, a social-networking system 802, and a third-party system 808 connected to each other by a network 804. Although FIG. 8 illustrates a particular arrangement of client system 806, social-networking system 802, third-party system 808, and network 804, this disclosure contemplates any suitable arrangement of client system 806, social-networking system 802, third-party system 808, and network 804. As an example and not by way of limitation, two or more of client system 806, social-networking system 802, and third-party system 808 may be connected to each other directly, bypassing network 804. As another example, two or more of client system 806, social-networking system 802, and third-party system 808 may be physically or logically co-located with each other in whole or in part. Moreover, although FIG. 8 illustrates a particular number of client systems 806, social-networking systems 802, third-party systems 808, and networks 804, this disclosure contemplates any suitable number of client systems 806, social-networking systems 802, third-party systems 808, and networks 804. As an example and not by way of limitation, network environment 800 may include multiple client system 806, social-networking systems 802, third-party systems 808, and networks 804.

This disclosure contemplates any suitable network 804. As an example and not by way of limitation, one or more portions of network 804 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 804 may include one or more networks 804.

Links may connect client system 806, social-networking system 802, and third-party system 808 to communication network 804 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 800. One or more first links may differ in one or more respects from one or more second links.

In particular embodiments, client system 806 may be an electronic device including hardware, software, or embedded logic components or a combination of two or more such components and capable of carrying out the appropriate functionalities implemented or supported by client system 806. As an example and not by way of limitation, a client system 806 may include any of the computing devices discussed above in relation to FIG. 7. A client system 806 may enable a network user at client system 806 to access network 804. A client system 806 may enable its user to communicate with other users at other client systems 806.

In particular embodiments, client system 806 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 806 may enter a Uniform Resource Locator (URL) or other address directing the web browser to a particular server (such as server, or a server associated with a third-party system 808), and the web browser may generate a Hyper Text Transfer Protocol (HTTP) request and communicate the HTTP request to server. The server may accept the HTTP request and communicate to client system 806 one or more Hyper Text Markup Language (HTML) files responsive to the HTTP request. Client system 806 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 802 may be a network-addressable computing system that can host an online social network. Social-networking system 802 may generate, store, receive, and send social-networking data, such as, for example, user-profile data, concept-profile data, social-graph information, or other suitable data related to the online social network. Social-networking system 802 may be accessed by the other components of network environment 800 either directly or via network 804. In particular embodiments, social-networking system 802 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social-networking system 802 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 806, a social-networking system 802, or a third-party system 808 to manage, retrieve, modify, add, or delete, the information stored in data store.

In particular embodiments, social-networking system 802 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social-networking system 802 may provide users of the online social network the ability to communicate and interact with other users. In particular embodiments, users may join the online social network via social-networking system 802 and then add connections (e.g., relationships) to a number of other users of social-networking system 802 whom they want to be connected to. Herein, the term “friend” may refer to any other user of social-networking system 802 with whom a user has formed a connection, association, or relationship via social-networking system 802.

In particular embodiments, social-networking system 802 may provide users with the ability to take actions on various types of items or objects, supported by social-networking system 802. As an example and not by way of limitation, the items and objects may include groups or social networks to which users of social-networking system 802 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 802 or by an external system of third-party system 808, which is separate from social-networking system 802 and coupled to social-networking system 802 via a network 804.

In particular embodiments, social-networking system 802 may be capable of linking a variety of entities. As an example and not by way of limitation, social-networking system 802 may enable users to interact with each other as well as receive content from third-party systems 808 or other entities, or to allow users to interact with these entities through an application programming interfaces (API) or other communication channels.

In particular embodiments, a third-party system 808 may include one or more types of servers, one or more data stores, one or more interfaces, including but not limited to APIs, one or more web services, one or more content sources, one or more networks, or any other suitable components, e.g., that servers may communicate with. A third-party system 808 may be operated by a different entity from an entity operating social-networking system 802. In particular embodiments, however, social-networking system 802 and third-party systems 808 may operate in conjunction with each other to provide social-networking services to users of social-networking system 802 or third-party systems 808. In this sense, social-networking system 802 may provide a platform, or backbone, which other systems, such as third-party systems 808, may use to provide social-networking services and functionality to users across the Internet.

In particular embodiments, a third-party system 808 may include a third-party content object provider. A third-party content object provider may include one or more sources of content objects, which may be communicated to a client system 806. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 802 also includes user-generated content objects, which may enhance a user's interactions with social-networking system 802. User-generated content may include anything a user can add, upload, send, or “post” to social-networking system 802. As an example and not by way of limitation, a user communicates posts to social-networking system 802 from a client system 806. Posts may include data such as status updates or other textual data, location information, photos, videos, links, music or other similar data or media. Content may also be added to social-networking system 802 by a third-party through a “communication channel,” such as a newsfeed or stream.

In particular embodiments, social-networking system 802 may include a variety of servers, sub-systems, programs, modules, logs, and data stores. In particular embodiments, social-networking system 802 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 802 may also include suitable components such as network interfaces, security mechanisms, load balancers, failover servers, management-and-network-operations consoles, other suitable components, or any suitable combination thereof. In particular embodiments, social-networking system 802 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 802 to one or more client systems 806 or one or more third-party system 808 via network 804. The web server may include a mail server or other messaging functionality for receiving and routing messages between social-networking system 802 and one or more client systems 806. An API-request server may allow a third-party system 808 to access information from social-networking system 802 by calling one or more APIs. An action logger may be used to receive communications from a web server about a user's actions on or off social-networking system 802. In conjunction with the action log, a third-party-content-object log may be maintained of user exposures to third-party-content objects. A notification controller may provide information regarding content objects to a client system 806. Information may be pushed to a client system 806 as notifications, or information may be pulled from client system 806 responsive to a request received from client system 806. Authorization servers may be used to enforce one or more privacy settings of the users of social-networking system 802. A privacy setting of a user determines how particular information associated with a user can be shared. The authorization server may allow users to opt in to or opt out of having their actions logged by social-networking system 802 or shared with other systems (e.g., third-party system 808), such as, for example, by setting appropriate privacy settings. Third-party-content-object stores may be used to store content objects received from third parties, such as a third-party system 808. Location stores may be used for storing location information received from client systems 806 associated with users. Advertisement-pricing modules may combine social information, the current time, location information, or other suitable information to provide relevant advertisements, in the form of notifications, to a user.

FIG. 9 illustrates example social graph 900. In particular embodiments, social-networking system 802 may store one or more social graphs 900 in one or more data stores. In particular embodiments, social graph 900 may include multiple nodes—which may include multiple user nodes 902 or multiple concept nodes 904—and multiple edges 906 connecting the nodes. Example social graph 900 illustrated in FIG. 9 is shown, for didactic purposes, in a two-dimensional visual map representation. In particular embodiments, a social-networking system 802, client system 806, or third-party system 808 may access social graph 900 and related social-graph information for suitable applications. The nodes and edges of social graph 900 may be stored as data objects, for example, in a data store (such as a social-graph database). Such a data store may include one or more searchable or query able indexes of nodes or edges of social graph 900.

In particular embodiments, a user node 902 may correspond to a user of social-networking system 802. As an example and not by way of limitation, a user may be an individual (human user), an entity (e.g., an enterprise, business, or third-party application), or a group (e.g., of individuals or entities) that interacts or communicates with or over social-networking system 802. In particular embodiments, when a user registers for an account with social-networking system 802, social-networking system 802 may create a user node 902 corresponding to the user, and store the user node 902 in one or more data stores. Users and user nodes 902 described herein may, where appropriate, refer to registered users and user nodes 902 associated with registered users. In addition, or as an alternative, users and user nodes 902 described herein may, where appropriate, refer to users that have not registered with social-networking system 802. In particular embodiments, a user node 902 may be associated with information provided by a user or information gathered by various systems, including social-networking system 802. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 904 may correspond to a concept. As an example and not by way of limitation, a concept may correspond to a place (such as, for example, a movie theater, restaurant, landmark, or city); a website (such as, for example, a website associated with social-network system 802 or a third-party website associated with a web-application server); an entity (such as, for example, a person, business, group, sports team, or celebrity); a resource (such as, for example, an audio file, video file, digital photo, text file, structured document, or application) which may be located within social-networking system 802 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 904 may be associated with information of a concept provided by a user or information gathered by various systems, including social-networking system 802. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 904 may be associated with one or more data objects corresponding to information associated with concept node 904. In particular embodiments, a concept node 904 may correspond to one or more webpages.

In particular embodiments, a node in social graph 900 may represent or be represented by a webpage (which may be referred to as a “profile page”). Profile pages may be hosted by or accessible to social-networking system 802. Profile pages may also be hosted on third-party websites associated with a third-party server 808. As an example and not by way of limitation, a profile page corresponding to a particular external webpage may be the particular external webpage and the profile page may correspond to a particular concept node 904. Profile pages may be viewable by all or a selected subset of other users. As an example and not by way of limitation, a user node 902 may have a corresponding user-profile page in which the corresponding user may add content, make declarations, or otherwise express himself or herself. As another example and not by way of limitation, a concept node 904 may have a corresponding concept-profile page in which one or more users may add content, make declarations, or express themselves, particularly in relation to the concept corresponding to concept node 904.

In particular embodiments, a concept node 904 may represent a third-party webpage or resource hosted by a third-party system 808. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 806 to send to social-networking system 802 a message indicating the user's action. In response to the message, social-networking system 802 may create an edge (e.g., an “eat” edge) between a user node 902 corresponding to the user and a concept node 904 corresponding to the third-party webpage or resource and store edge 906 in one or more data stores.

In particular embodiments, a pair of nodes in social graph 900 may be connected to each other by one or more edges 906. An edge 906 connecting a pair of nodes may represent a relationship between the pair of nodes. In particular embodiments, an edge 906 may include or represent one or more data objects or attributes corresponding to the relationship between a pair of nodes. As an example and not by way of limitation, a first user may indicate that a second user is a “friend” of the first user. In response to this indication, social-networking system 802 may send a “friend request” to the second user. If the second user confirms the “friend request,” social-networking system 802 may create an edge 906 connecting the first user's user node 902 to the second user's user node 902 in social graph 900 and store edge 906 as social-graph information in one or more of data stores. In the example of FIG. 9, social graph 900 includes an edge 906 indicating a friend relation between user nodes 902 of user “A” and user “B” and an edge indicating a friend relation between user nodes 902 of user “C” and user “B.” Although this disclosure describes or illustrates particular edges 906 with particular attributes connecting particular user nodes 902, this disclosure contemplates any suitable edges 906 with any suitable attributes connecting user nodes 902. As an example and not by way of limitation, an edge 906 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 900 by one or more edges 906.

In particular embodiments, an edge 906 between a user node 902 and a concept node 904 may represent a particular action or activity performed by a user associated with user node 902 toward a concept associated with a concept node 904. As an example and not by way of limitation, as illustrated in FIG. 9, a user may “like,” “attended,” “played,” “listened,” “cooked,” “worked at,” or “watched” a concept, each of which may correspond to an edge type or subtype. A concept-profile page corresponding to a concept node 904 may include, for example, a selectable “check in” icon (such as, for example, a clickable “check in” icon) or a selectable “add to favorites” icon. Similarly, after a user clicks these icons, social-networking system 802 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 802 may create a “listened” edge 906 and a “used” edge (as illustrated in FIG. 9) between user nodes 902 corresponding to the user and concept nodes 904 corresponding to the song and application to indicate that the user listened to the song and used the application. Moreover, social-networking system 802 may create a “played” edge 906 (as illustrated in FIG. 9) between concept nodes 904 corresponding to the song and the application to indicate that the particular song was played by the particular application. In this case, “played” edge 906 corresponds to an action performed by an external application (SPOTIFY) on an external audio file (the song “Imagine”). Although this disclosure describes particular edges 906 with particular attributes connecting user nodes 902 and concept nodes 904, this disclosure contemplates any suitable edges 906 with any suitable attributes connecting user nodes 902 and concept nodes 904. Moreover, although this disclosure describes edges between a user node 902 and a concept node 904 representing a single relationship, this disclosure contemplates edges between a user node 902 and a concept node 904 representing one or more relationships. As an example and not by way of limitation, an edge 906 may represent both that a user likes and has used at a particular concept. Alternatively, another edge 906 may represent each type of relationship (or multiples of a single relationship) between a user node 902 and a concept node 904 (as illustrated in FIG. 9 between user node 902 for user “E” and concept node 904 for “SPOTIFY”).

In particular embodiments, social-networking system 802 may create an edge 906 between a user node 902 and a concept node 904 in social graph 900. As an example and not by way of limitation, a user viewing a concept-profile page (such as, for example, by using a web browser or a special-purpose application hosted by the user's client system 806) may indicate that he or she likes the concept represented by the concept node 904 by clicking or selecting a “Like” icon, which may cause the user's client system 806 to send to social-networking system 802 a message indicating the user's liking of the concept associated with the concept-profile page. In response to the message, social-networking system 802 may create an edge 906 between user node 902 associated with the user and concept node 904, as illustrated by “like” edge 906 between the user and concept node 904. In particular embodiments, social-networking system 802 may store an edge 906 in one or more data stores. In particular embodiments, an edge 906 may be automatically formed by social-networking system 802 in response to a particular user action. As an example and not by way of limitation, if a first user uploads a picture, watches a movie, or listens to a song, an edge 906 may be formed between user node 902 corresponding to the first user and concept nodes 904 corresponding to those concepts. Although this disclosure describes forming particular edges 906 in particular manners, this disclosure contemplates forming any suitable edges 906 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on social-networking system 802). A sponsored story may be a social action by a user (such as “liking” a page, “liking” or commenting on a post on a page, RSVP′ing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition, or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social-networking system 802 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social-networking system 802) or RSVP (e.g., through social-networking system 802) to an event associated with the advertisement. In addition, or as an alternative, an advertisement may include social-networking-system context directed to the user. As an example and not by way of limitation, an advertisement may display information about a friend of the user within social-networking system 802 who has taken an action associated with the subject matter of the advertisement.

In particular embodiments, social-networking system 802 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 808 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 802 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 802 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 802 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 802 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 802 may calculate a coefficient based on a user's actions. Social-networking system 802 may monitor such actions on the online social network, on a third-party system 808, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social-networking system 802 may calculate a coefficient based on the user's actions with particular types of content. The content may be associated with the online social network, a third-party system 808, or another suitable system. The content may include users, profile pages, posts, news stories, headlines, instant messages, chat room conversations, emails, advertisements, pictures, video, music, other suitable objects, or any combination thereof. Social-networking system 802 may analyze a user's actions to determine whether one or more of the actions indicate an affinity for subject matter, content, other users, and so forth. As an example and not by way of limitation, if a user may make frequently posts content related to “coffee” or variants thereof, social-networking system 802 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 802 may calculate a coefficient based on the type of relationship between particular objects. Referencing the social graph 900, social-networking system 802 may analyze the number and/or type of edges 906 connecting particular user nodes 902 and concept nodes 904 when calculating a coefficient. As an example and not by way of limitation, user nodes 902 that are connected by a spouse-type edge (representing that the two users are married) may be assigned a higher coefficient than user nodes 902 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 802 may determine that the user has a higher coefficient with respect to the first photo than the second photo because having a tagged-in-type relationship with content may be assigned a higher weight and/or rating than having a like-type relationship with content. In particular embodiments, social-networking system 802 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 802 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 900. As an example and not by way of limitation, social-graph entities that are closer in the social graph 900 (i.e., fewer degrees of separation) may have a higher coefficient than entities that are further apart in the social graph 900.

In particular embodiments, social-networking system 802 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 806 of the user). A first user may be more interested in other users or concepts that are closer to the first user. As an example and not by way of limitation, if a user is one mile from an airport and two miles from a gas station, social-networking system 802 may determine that the user has a higher coefficient for the airport than the gas station based on the proximity of the airport to the user.

In particular embodiments, social-networking system 802 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 802 may provide information that is relevant to user's interests and current circumstances, increasing the likelihood that they will find such information of interest. In particular embodiments, social-networking system 802 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 802 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 802 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 808 (e.g., via an API or other communication channel), or from another suitable system. In response to the request, social-networking system 802 may calculate the coefficient (or access the coefficient information if it has previously been calculated and stored). In particular embodiments, social-networking system 802 may measure an affinity with respect to a particular process. Different processes (both internal and external to the online social network) may request a coefficient for a particular object or set of objects. Social-networking system 802 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/978,027, filed 22 Dec. 2010, U.S. patent application Ser. No. 12/978,265, filed 23 Dec. 2010, and U.S. patent application Ser. No. 13/642,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 904 corresponding to a particular photo may have a privacy setting specifying that the photo may only be accessed by users tagged in the photo and their friends. In particular embodiments, privacy settings may allow users to opt in or opt out of having their actions logged by social-networking system 802 or shared with other systems (e.g., third-party system 808). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 808, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social-networking system 802 may send a request to the data store for the object. The request may identify the user associated with the request and may only be sent to the user (or a client system 806 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

What is claimed is:

1. A method, comprising:
receiving, at one or more servers of a social networking system, a request from a user to initiate a peer-to-peer loan transaction;
establishing, by the one or more servers, loan terms for the requested loan transaction;
recommending to the user, by the one or more servers, one or more potential lenders from a plurality of co-users of the social networking system likely to loan money to the user based on information maintained by the social networking system;
providing, by the one or more servers, a loan request message to a potential lender of the one or more potential lenders;
receiving, at the one or more servers, an acceptance of the requested loan transaction for a first loan amount by the potential lender; and
initiating the loan transaction between the user and the potential lender according to the established loan terms by transferring the loan amount from a payment credential of the potential lender to a payment credential of the user.

2. The method as recited in claim 1, wherein receiving an acceptance of the requested loan transaction for a first loan amount by the potential lender comprises receiving the acceptance of the requested loan transaction for a first partial amount of a full requested amount associated with the requested loan transaction.

3. The method as recited in claim 2, further comprising:
providing the loan request message to a second potential lender of the one or more potential lenders;
receiving an acceptance of the requested loan transaction for a second loan amount by the second potential lender, wherein the second loan amount is a second partial amount of the full requested amount; and
initiating a second loan transaction between the user and the second potential lender according to the established loan terms by transferring the second loan amount from a payment credential of the second potential lender to a payment credential of the user.

4. The method as recited in claim 1, wherein establishing the loan terms for the requested loan transaction comprises receiving loan terms selected by the user.

5. The method as recited in claim 1, wherein establishing the loan terms for the requested loan transaction comprises recommending default loan terms based on the information maintained by the social networking system.

6. The method as recited in claim 1, wherein establishing the loan terms for the requested loan transaction comprises establishing a repayment plan comprising one or more repayment amounts of the loan amount to the potential lender according to a repayment schedule.

7. The method as recited in claim 1, further comprising:
receiving, from a vouching co-user of the social networking system, a guarantee of the loan transaction to repay the loan amount to the potential lender;
determining that the user defaults on one or more repayments of the loan amount to the potential lender; and
transferring a default amount from a payment credential of the vouching co-user to the payment credential of the potential lender.

8. The method as recited in claim 1, wherein the information maintained by the social networking system comprises information about previous loan transactions and payment transactions for the plurality of co-users of the social networking system.

9. A system, comprising:
at least one processor; and
at least one non-transitory computer-readable storage medium storing instructions thereon that, when executed by the at least one processor, cause the system to:
receive, at a social networking system, a request from a user to initiate a peer-to-peer loan transaction;
establish loan terms for the requested loan transaction;
recommend to the user one or more potential lenders from a plurality of co-users of the social networking system likely to loan money to the user based on information maintained by the social networking system;
provide a loan request message to a potential lender of the one or more potential lenders;
receive an acceptance of the requested loan transaction for a first loan amount by the potential lender; and
initiate the loan transaction between the user and the potential lender according to the established loan terms by transferring the loan amount from a payment credential of the potential lender to a payment credential of the user.

10. The system as recited in claim 9, wherein receiving an acceptance of the requested loan transaction for a first loan amount by the potential lender comprises receiving the acceptance of the requested loan transaction for a first partial amount of a full requested amount associated with the requested loan transaction.

11. The system as recited in claim 10, further comprising instructions that, when executed by the at least one processor, cause the system to:
provide the loan request message to a second potential lender of the one or more potential lenders;
receive an acceptance of the requested loan transaction for a second loan amount by the second potential lender, wherein the second loan amount is a second partial amount of the full requested amount; and
initiate a second loan transaction between the user and the second potential lender according to the established loan terms by transferring the second loan amount from a payment credential of the second potential lender to a payment credential of the user.

12. The system as recited in claim 9, wherein establishing the loan terms for the requested loan transaction comprises receiving loan terms selected by the user.

13. The system as recited in claim 9, wherein establishing the loan terms for the requested loan transaction comprises recommending default loan terms based on the information maintained by the social networking system.

14. The system as recited in claim 9, wherein establishing the loan terms for the requested loan transaction comprises establishing a repayment plan comprising one or more repayment amounts of the loan amount to the potential lender according to a repayment schedule.

15. The system as recited in claim 9, further comprising instructions that, when executed by the at least one processor, cause the system to:
receive, from a vouching co-user of the social networking system, a guarantee of the loan transaction to repay the loan amount to the potential lender;
determine that the user defaults on one or more repayments of the loan amount to the potential lender; and
transfer a default amount from a payment credential of the vouching co-user to the payment credential of the potential lender.

16. A non-transitory computer readable medium storing instructions thereon that, when executed by at least one processor, cause the at least one processor to perform steps comprising:
receiving, at a social networking system, a request from a user to initiate a peer-to-peer loan transaction;
establishing loan terms for the requested loan transaction;
recommending to the user one or more potential lenders from a plurality of co-users of the social networking system likely to loan money to the user based on information maintained by the social networking system;
providing a loan request message to a potential lender of the one or more potential lenders;
receiving an acceptance of the requested loan transaction for a first loan amount by the potential lender; and
initiating the loan transaction between the user and the potential lender according to the established loan terms by transferring the loan amount from a payment credential of the potential lender to a payment credential of the user.

17. The non-transitory computer readable medium as recited in claim 16, wherein receiving an acceptance of the requested loan transaction for a first loan amount by the potential lender comprises receiving the acceptance of the requested loan transaction for a first partial amount of a full requested amount associated with the requested loan transaction.

18. The non-transitory computer readable medium as recited in claim 17, further comprising instructions that, when executed by the at least one processor, cause the at least one processor to perform steps comprising:
providing the loan request message to a second potential lender of the one or more potential lenders;
receiving an acceptance of the requested loan transaction for a second loan amount by the second potential lender, wherein the second loan amount is a second partial amount of the full requested amount; and
initiating a second loan transaction between the user and the second potential lender according to the established loan terms by transferring the second loan amount from a payment credential of the second potential lender to a payment credential of the user.

19. The non-transitory computer readable medium as recited in claim 16, wherein establishing the loan terms for the requested loan transaction comprises establishing a repayment plan comprising one or more repayment amounts of the loan amount to the potential lender according to a repayment schedule.

20. The non-transitory computer readable medium as recited in claim 16, further comprising instructions that, when executed by the at least one processor, cause the at least one processor to perform steps comprising:
receiving, from a vouching co-user of the social networking system, a guarantee of the loan transaction to repay the loan amount to the potential lender;
determining that the user defaults on one or more repayments of the loan amount to the potential lender; and
transferring a default amount from a payment credential of the vouching co-user to the payment credential of the potential lender.
